(19) United States
(12) Patent Application Publication
(10) Pub. No.: US 2025/0299539 A1
(43) Pub. Date: Sep. 25, 2025

(54) SYSTEMS AND METHODS FOR REMOTELY PLAYING ARCADE GAMES

(71) Applicant: THE WORKS AT WYOMISSING, LLC, Wyomissing Berks, PA (US)

(72) Inventors: William Fields White, Birdsboro, PA (US); Mark Andrew Nye, Robesonia, PA (US)

(21) Appl. No.: 18/611,320

(22) Filed: Mar. 20, 2024

Related U.S. Application Data
(60) Provisional application No. 63/453,300, filed on Mar. 20, 2023.

(51) Int. Cl. G07F 17/32

(52) U.S. Cl. CPC G07F 17/3297; G07F 17/3209; G07F 17/3225; G07F 17/3241

(57) ABSTRACT

A system and method for playing arcade games from a remote location is disclosed. The system comprises a user device, an application server, a media streaming unit, a game controlling unit, and a game machine communicatively connected using a communication network. The system enables a user to play arcade games on a remotely located game machine using the user device. The system further enables the user to redeem rewards in a physical manner or in exchange for coins or other game currency. The rewards redeemed in the physical manner can further be shipped to the user.

### BACKGROUND

### Field of Disclosure

Embodiments disclosed herein relate, in general, to stationary arcade game machines with remote video viewing and localized control and, more particularly, to methods and system for playing arcade games remotely.

### Description of Related Art

Leisure and entertainment activities are an integral part of an individual's lifestyle. One such form of entertainment becoming increasingly prevalent is electronic gaming. Personal electronic gaming consoles and devices are available in various sizes and shapes, and with the development in technologies, the size, form factor and cost of the gaming consoles has been shrinking over time. Many currently available personal electronic gaming consoles are portable and economical. Some currently available examples include, but are not limited to, consumer-grade smartphones, Steam Deck, and AYA NEO.

Despite advances in personal electronic gaming console technology, physical arcade gaming environments with dedicated gaming consoles (e.g., amusement arcade venues) remain a popular form of entertainment amongst their users. For many users, arcade gaming environments provide a social atmosphere where users stimulate competitive rivalries. Arcade gaming environments also encourage gameplay through rewards won from the gaming consoles, such as, but not limited to, toys, gifts, cash prizes, reward points, and so forth.

However, arcade gaming environments are facing increasing competition from home gaming systems and portable gaming consoles because they require the user to be physically present at the arcade gaming environment. Current physical arcade gaming environments are further disadvantaged in that: (a) physical arcade gaming environments require an investment of time from a user to travel to and from the geographic location of the arcade gaming environment; (b) the arcade game machines cannot be played anywhere/anytime as is the case with home gaming systems and portable gaming consoles; (c) physical arcade gaming environments are typically located in more densely populated areas, and therefore are not accessible to all potential customers; and (d) physical arcade gaming environments may limit the quantity and quality of the prize selection available to customers, as well as the ability to quickly and conveniently ship prizes to the customer.

Additionally, the number of available arcade game machines in a given arcade gaming environment can be less than the number of users at the physical arcade gaming environment, or the number of users desiring to play a given arcade game machine or category of arcade game machine can exceed capacity of the arcade gaming environment. Accordingly, a user may have to physically wait in a queue in the vicinity of a particular arcade game machine for a significant amount of time for their turn to play the game. Further still, one or more other arcade game machines may be available, but may not be utilized, because the user is waiting in a queue at a particular arcade game machine and is unaware of the other available arcade game machines, for example, located in another area of the arcade gaming environment.

Thus, there is a need for systems and methods for playing arcade games from a remote location in a real-time for users who desire to play arcade games but are unable or unwilling to be physically present at arcade gaming centers.

### SUMMARY

The present disclosure provides systems and methods for remotely playing arcade games. The systems of the present disclosure can include: a user management module configured to enable onboarding of a new user by registering the user on the system with pre-defined details, and generating an avatar of the new user, wherein the pre-defined details are selected from a name, an age, a gender, an address and a postal code, an interest, a username, a credential, a phone number, an electronic mail, or a combination thereof. The user management module is further configured to enable the user to log in to the system by utilizing the log in credentials such as, but not limited to, the username and the password. The user management module is further configured to enable the user to recover a lost and/or forgotten credentials.

According to some embodiments, the system includes a service provider management module configured to enable onboarding of a new service provider by providing pre-set details of the service provider, wherein the pre-set details are selected from a name of the service provider, a location of the service provider, a type of the game machine, provided by the service provider, or a combination thereof.

According to some embodiments, the system includes a game machine management module configured to enable a management of game machines by storing information related to the game machines in a database, wherein the information related to the game machines is selected from a name of the game machine, a type of the game machine, a location for installation of the game machine, types of rewards rewarded by the game machine, an active timings of the game machine, or a combination thereof.

According to some embodiments, the system includes a game selection module configured to enable the user to select a game to be remotely played from a catalog of games. The game selection module can be further configured to enable the user to play a demonstration of the selected game.

According to some embodiments, the system includes a payment module configured to check a balance of coins in a wallet of the user with a number of coins required for remotely playing of the selected game. The payment module is further configured to enable the user to recharge the wallet by utilization of real currency.

According to some embodiments, the system includes a game play module configured to check a current status of a remote game machine corresponding to the selected game. The game play module is further configured to enable the user to remotely play the selected game on the corresponding game machine, wherein the user provides input to the game machine by using a user provided device.

According to some embodiments, the system includes a reward redemption module configured to check a validity of the rewards rewarded to the user. The reward redemption module is further configured to enable the user to redeem the rewards, wherein the redemption process of the rewards is selected from a physical shipment of the reward, an exchange of the rewards with coins, or a combination thereof. According to further embodiments of the present disclosure, the user can redeem a prize, or other reward, in exchange for a specified (e.g., minimum) number of tickets and/or other game currency. According to some embodiments, the system includes a notification module configured to generate one or more notifications and then transmit the notifications to the user device, wherein the notifications are selected from a successful login of the user, a failure attempt for logging in of the user, a demonstration game play for the user, a low coin balance in the wallet, an availability of the game machine, a winning status of the game, an introduction of a new game machine, an expiration of the rewards, or a combination thereof.

The present disclosure also provides methods for remotely playing arcade games. The methods can include the steps of, onboarding of a new user by registering the user on a system; enabling the user to log in to the system; enabling the user to select a game to be played remotely; enabling the user to remotely play the selected game; and enabling the user to redeem rewards won in the games remotely played on the game machine of the system.

The present disclosure also provides methods for remotely playing arcade games. The methods can include the steps of: onboarding of a new game machine into the system. The onboarding may include hardware such as custom harnesses and printed circuit boards (PCBs). The onboarding may include use of software such as device hardening scripts, active and passive scripts, and active and passive binaries. This software described in may interface with device memory and kernel-only memory, in addition to userspace memory. In some examples, memory can be shared memory via system bus hardware and software. In other examples, memory usage can be limited to specific methods and procedures that require state sense while operating.

Some embodiments of the present disclosure provide systems and methods for remote playing arcade games that enable monetization of idle game machines (e.g., machines not currently in use by a local player) installed at physical locations. In other words, the present disclosure provides systems and methods to enable a game machine not being played by a user at a physical arcade location to be made available to remote users for online gameplay. Additional embodiments of the present disclosure provide systems and methods for playing arcade games configured exclusively for remote gameplay. Game machines can be outfitted to be played both physically (e.g., locally, and/or remotely without any additional changes from workers.

Some embodiments of the present disclosure provide systems and methods for playing arcade games that enable remote playing of conventional arcade games.

Some embodiments of the present disclosure provide systems and methods for converting score point values won during conventional arcade type gameplay to ticket values for use in accordance with rules of tickets won by other methods described in the present application.

Some embodiments of the present disclosure provide systems and methods for remote playing arcade games that provide remote real-time interaction with game machines.

Some embodiments of the present disclosure provide systems and methods for synchronizing video and control streams to operate equipment with coordinated control and video.

Some embodiments of the present disclosure provide systems and methods for remote playing arcade games that facilitate home shipments of rewards won.

Some embodiments of the present disclosure provide systems and methods for remote playing arcade games that are easy to understand and easy to operate.

Some embodiments of the present disclosure provide systems and methods for offering and/or hosting machines that can be remotely played.

These and other advantages will be apparent from the present application of the embodiments described herein.

The preceding is a simplified summary to provide an understanding of some embodiments of the present disclosure. This summary is neither an extensive nor exhaustive overview of the present disclosure and its various embodiments. The summary presents selected concepts of the embodiments of the present disclosure in a simplified form as an introduction to the more detailed description presented below. As will be appreciated, other embodiments of the present disclosure are possible utilizing, alone or in combination, one or more of the features set forth above or described in detail below.

### BRIEF DESCRIPTION OF THE DRAWINGS

The foregoing and other aspects of the embodiments disclosed herein are best understood from the following detailed description when read in connection with the accompanying drawings. For the purpose of illustrating the embodiments disclosed herein, there is shown in the drawings embodiments that are presently preferred, it being understood, however, that the embodiments disclosed herein are not limited to the specific instrumentalities disclosed. Included in the drawings are the following figures:

FIG. 1 illustrates a block diagram depicting a system for remotely playing arcade games, according to embodiments of the present disclosure;

FIG. 2 illustrates a block diagram depicting a communication network of the system for remotely playing arcade games, according to embodiments of the present disclosure;

FIG. 3 illustrates a block diagram depicting a gaming platform of the system for remotely playing arcade games, according to embodiments of the present disclosure;

FIG. 4 illustrates an architecture schema of the system for remotely playing arcade games, according to embodiments of the present disclosure;

FIG. 5A illustrates a method for remotely playing arcade games, according to embodiments of the present disclosure;

FIG. 5B illustrates a method for game play on the system for remotely playing arcade games, according to embodiments of the present disclosure;

FIG. 5C illustrates a method to manage balance coins on the system for remotely playing arcade games, according to embodiments of the present disclosure;

FIG. 5D illustrates a method for reward redemption on the system for remotely playing arcade games, according to embodiments of the present disclosure;

FIG. 6A illustrates an exemplary registration page of a gaming application of the system, according to embodiments of the present disclosure;

FIG. 6B illustrates an exemplary login page of the gaming application, according to embodiments of the present disclosure;

FIG. 6C illustrates an exemplary reset credentials page of the gaming application, according to embodiments of the present disclosure;

FIG. 7 illustrates an exemplary game catalog page of the gaming application, according to embodiments of the present disclosure;

FIG. 8A illustrates an exemplary demonstration game start page of the gaming application, according to embodiments of the present disclosure;

FIG. 8B illustrates another exemplary demonstration game play page of the gaming application, according to embodiments of the present disclosure;

FIG. 8C illustrates an exemplary notification for a demonstration game-winning page of the gaming application, according to embodiments of the present disclosure;

FIG. 9A illustrates an exemplary notification depicting a waiting queue page of the gaming application, according to embodiments of the present disclosure;

FIG. 9B illustrates an exemplary notification depicting a turn arrival page of the gaming application, according to embodiments of the present disclosure;

FIG. 9C illustrates an exemplary game start page of the gaming application, according to embodiments of the present disclosure;

FIG. 9D illustrates an exemplary game play page of the gaming application, according to embodiments of the present disclosure;

FIG. 9E illustrates an exemplary game wining page of the gaming application, according to embodiments of the present disclosure;

FIG. 9F illustrates an exemplary notification depicting a game-losing page of the gaming application, according to embodiments of the present disclosure;

FIG. 10A illustrates an exemplary game home page of the gaming application, according to embodiments of the present disclosure;

FIG. 10B illustrates an exemplary game record home page displaying records for all types of games played previously on the gaming application, according to embodiments of the present disclosure;

FIG. 10C illustrates an exemplary game record home page displaying records for claw machine games previously played on the gaming application, according to embodiments of the present disclosure;

FIG. 10D illustrates an exemplary game record home page displaying records for coin pusher games previously played on the gaming application, according to embodiments of the present disclosure;

FIG. 10E illustrates an exemplary game record home page displaying records for other arcade games previously played on the gaming application, according to embodiments of the present disclosure;

FIG. 11A illustrates an exemplary game home page of the gaming application, according to embodiments of the present disclosure;

FIG. 11B illustrates an exemplary profile home page of the gaming application, according to embodiments of the present disclosure;

FIG. 11C illustrates an exemplary rewards won page of the gaming application, according to embodiments of the present disclosure;

FIG. 11D illustrates an exemplary notification to redeem a reward in the gaming application, according to embodiments of the present disclosure;

FIG. 11E illustrates an exemplary notification for a successful reward redemption of the gaming application, according to embodiments of the present disclosure;

FIG. 11F illustrates an exemplary shipped reward page of the gaming application, according to embodiments of the present disclosure;

FIG. 11G illustrates an exemplary delivered reward page of the gaming application, according to embodiments of the present disclosure;

FIG. 11H illustrates an exemplary reward shipment page of the gaming application, according to embodiments of the present disclosure;

FIG. 12A illustrates an exemplary coin balance page of the gaming application, according to embodiments of the present disclosure; and

FIG. 12B illustrates an exemplary coin balance history page of the gaming application, according to embodiments of the present disclosure.

While embodiments of the present disclosure are described herein by way of example using several illustrative drawings, those skilled in the art will recognize the present disclosure is not limited to the embodiments or drawings described. It should be understood the drawings and the detailed description thereto are not intended to limit the present disclosure to the particular form disclosed, but to the contrary, the present disclosure is to cover all modifications, equivalents, and alternatives falling within the spirit and scope of embodiments of the present disclosure as defined by the description.

The headings used herein are for organizational purposes only and are not meant to be used to limit the scope of the description. As used throughout this application, the word “can” is used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

### DETAILED DESCRIPTION

Embodiments of the present disclosure are described below in conjunction with an exemplary gaming system. Embodiments of the present disclosure are not limited to any particular type of a gaming system. Those skilled in the art can recognize the disclosed techniques can be used in any gaming system in which it is desirable to provide a platform to a user to play arcade games from a remote location.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B, and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation is performed. Human input that consents to the performance of the process or operation is not deemed to be “material”.

The terms “determine,” “calculate” and “compute,” and variations thereof, as used herein, are used interchangeably and include any type of methodology, process, mathematical operation, or technique.

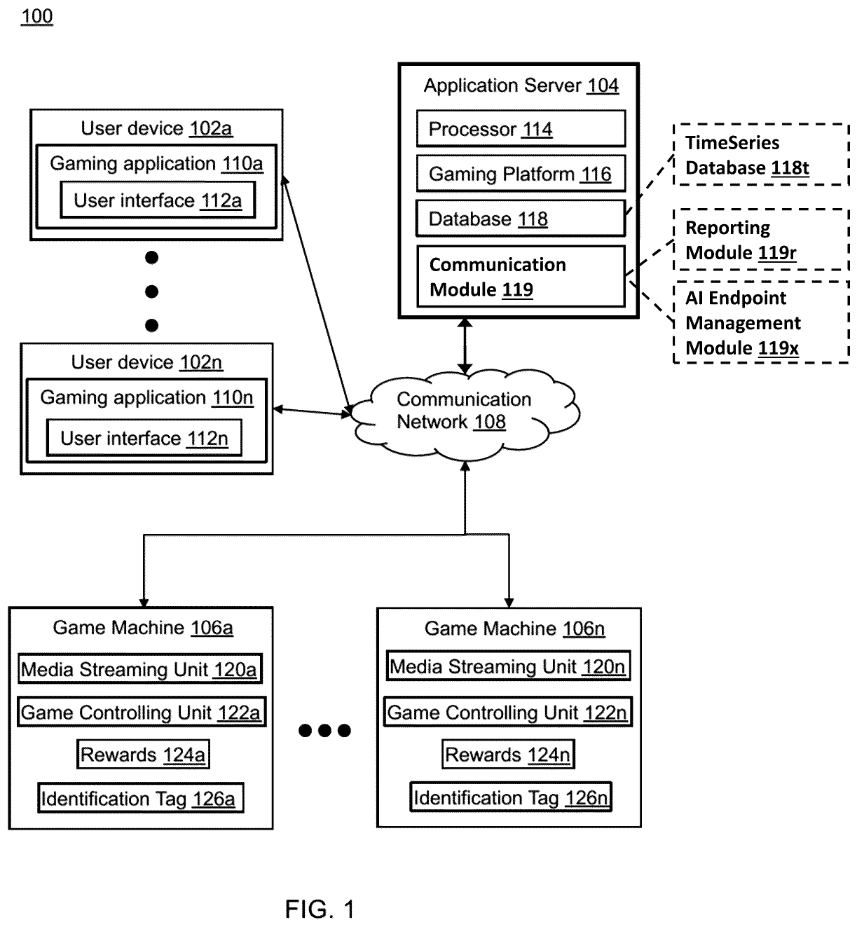

FIG. 1 illustrates a block diagram depicting an exemplary system 100 for playing arcade games. According to embodiments of the present disclosure, the system 100 enables a user to remotely play the arcade games. In some embodiments of the present disclosure, the system 100 can reward the user upon winning in the arcade game being played from a remote location, such as, for example, by providing (e.g., shipping) a physical prize to the user or by providing game currency (e.g., coins, credits, tickets, tokens, etc.) to the user.

According to embodiments of the present disclosure, the system 100 can include one or more user devices 102a-102n (hereinafter individually referred to as the “user device 102”), an application server 104, and one or more game machines 106a-106m (hereinafter individually referred to as the “game machine 106”). The user device 102, the application server 104, and the game machine 106 can be communicatively connected using a communication network 108, according to embodiments of the present disclosure.

According to embodiments of the present disclosure, the user device 102 can include a gaming application 110a-110n (hereinafter individually referred to as the “gaming application 110”). The gaming application 110 can further include a user interface 112a-112n (hereinafter individually referred to as the “user interface 112”). According to embodiments of the present disclosure, the user device 102 can further provide input means (not shown), that enable the user to interact with the user interface 112 of the gaming application 110. The input means of the user device 102 can be, but is not limited to, a wireless gestured enabled input means, a touch enabled input means, a mouse, a keyboard, a joystick, a directional pad, and so forth. Embodiments of the present disclosure are intended to include or otherwise cover any input means provided in the user device 102 that can enable interaction of the user with the gaming application 110, including known, related art, and/or later developed technologies.

According to some aspects of the present disclosure, the gaming application 110 can be in communication with, or integrate, one or more existing gaming platform applications having “live” streaming technology, such as, but not limited to, Discord, Twitch, Facebook, and Steam. Furthermore, communication and/or integration with one or more live multiplayer gaming environments, such as, but not limited to, Minecraft, and other Simulated world environments, provides players with access to the disclosed video and gaming controls of the present disclosure, from within the live gaming environments themselves.

According to embodiments of the present disclosure, the user device 102 enables a user to transmit and receive data relating to the system 100. The data may include, but is not limited to, data formatted or encoded according to IP protocols, TCP and/or UDP protocols, streaming software utilizing compression algorithms, and the like, to provide the user with synchronized video and control of the machine. According to some embodiments of the present disclosure, TCP packet headers are modified to include control information strings (e.g., bits mapped to control commands for the game machines) stored therein. As those of ordinary skill in the art will understand, bits in the header that are not being utilized for TCP communication are “padded” with zeroes in order to remain compliant with the TCP communication protocol (e.g., RFC 9293, 793, 879, 2873, 6093, 6429, 6528, 6691, or the like). Instead of filling these unused bits with zeroes, the system of the present disclosure replaces the unused bits in the TCP header with bits comprising control information strings for controlling operation of the game machines 106, which would otherwise have to be included elsewhere in the packet data. Accordingly, by modifying the headers to replace the unused bits with control information strings, the header remains TCP compliant, the overall size of the packet is reduced, and packet fragmentation is reduced, thereby making stateful connection packet processing more efficient. Moreover, the efficiency gained provides for the system of the present disclosure to operate faster (e.g., by transmitting less data) and be more scalable with current hardware. The user device 102 can enable onboarding of the user on the system 100 by receiving user details. After the onboarding procedure, the user device 102 can enable the user to remotely play the arcade game in the game machine 106 as set forth herein. According to embodiments of the present disclosure, the user details can include, but are not limited to, a name of the user, an age of the user, a gender of the user, an address and a postal code of the user, an interest of the user, a username of the user, a credential of the user, a phone number of the user, an electronic mail of the user, an avatar of the user, a profile picture of the user, an account details, and so forth. Embodiments of the present disclosure are intended to include or otherwise cover any other user details that can be provided by the user through the user device 102 for onboarding on the system 100, including known, related art, and/or later developed technologies.

According to embodiments of the present disclosure, the avatar of the user can include representative features such as, but not limited to, eyes or hair, or any other body part of the user that can be used to generate the avatar of the user, and so forth. Embodiments of the present disclosure are intended to include or otherwise cover any features that can help in representation of the avatar of the user, including known, related art, and/or later developed technologies.

According to embodiments of the present disclosure, the avatar of the user could be linked with common interfaces or databases having currently defined or pre-existing avatars owned by the user. One or more of these avatars could be used with the system 100, rather than an avatar generated by way of the systems and methods of the present disclosure.

The user device 102 can further provide a means for authentication of the user onto the system 100, according to embodiments of the present disclosure. According to embodiments of the present disclosure, the means for authentication of the user onto the system 100 can utilize components installed in the user device 102. The components installed in the user device 102 for authentication of the user can be, but are not limited to, a fingerprint sensor to authenticate the user using fingerprints, an iris sensor to authenticate the user using the iris, an image capturing unit to authenticate the user using facial identification and recognition, a microphone to authenticate the user using vocal characteristics, and similar biometric identification technology. Embodiments of the present disclosure are intended to include or otherwise cover any components installed in the user device 102 that can be utilized for authentication of the user, including known, related art, and/or later developed technologies.

According to embodiments of the present disclosure, the user device 102 can further enable the user to redeem the rewards 124 won after playing the arcade game in the game machine 106.

The user device 102 can be, but is not limited to, a mobile device, a smart phone, a tablet computer, a portable computer, a laptop computer, and so forth. Embodiments are intended to include or otherwise cover any type of user device 102, including known, related art, and/or later developed technologies.

Further, according to embodiments of the present disclosure, the service provider device can be, but is not limited to, a handheld device, a tablet, a mobile phone, a notebook, a netbook, a smartphone, a wearable device, and other technologies supporting multimedia application programming interfaces (APIs). Embodiments of the present disclosure are intended to include or otherwise cover any type of service provider device including known, related art, and/or later developed technologies.

According to an embodiment of the present disclosure, the user device 102 can include software applications such as, but not limited to, a digital wallet application, a payment application, a gameplay recording application, and the like. Additionally, the user device 102 can include the gaming application 110 that can be a computer-readable program installed in the user device 102 for executing functions associated with the system 100. According to embodiments of the present disclosure, the gaming application 110 can be compatible with any digital computing environment and operating system such as, but not limited to, Linux based distributions, Unix based distributions, Apple products, Google products, custom common Unix Display Xsystem variants, an Android operating system, a Windows operating system, an Apple Operating System (iOS), a Macintosh operating system (MAC OS), a Linux operating system, a Debian operating system, and so forth. Embodiments of the present disclosure are intended to include or otherwise cover any digital computing environment and operating system for which the gaming application 110 can be compatible, including known, related art, and/or later developed technologies.

One or more of the executed functions associated with the system 100, that can be performed by the user using the user device 102, can be displayed on a display unit (not shown) of the user device 102. The display unit of the user device 102 can provide the user interface 112 that can facilitate an interaction of the user with the user device 102 via the display unit. According to embodiments of the present disclosure, the display unit can be arranged in front of the user device 102. According to embodiments of the present disclosure, the display unit can include, but is not limited to, a Liquid Crystal Display (LCD), a Light Emitting Diode (LED) display, an Organic Light Emitting Diode (OLED) display, and so forth. Further, the display unit can feature a backlight that can be turned on and/or turned off based on a requirement. Embodiments of the present disclosure are intended to include or otherwise cover any type of the display unit installed in the user device 102 including known, related art, and/or later developed technologies.

According to embodiments of the present disclosure, the application server 104 can include a processor 114, a gaming platform 116, a database 118, and a communication module 119. Application server 104 may also include cloud-based instances of operating systems (e.g., virtual machines), local OS installations, and the like.

According to embodiments of the present disclosure, the application server 104 can represent hardware and/or software on which the processor 114 can be installed. According to embodiments of the present disclosure, the application server 104 can include, but is not limited to, a motherboard, a wired board, a mainframe, and so forth. Embodiments of the present disclosure are intended to include or otherwise cover any type of the application server 104, including known, related art, and/or later developed technologies. According to embodiments of the present disclosure, the application server 104 can be installed in an enclosure such as, but not limited to, a cabinet, a server rack, a wall-board and so forth. According to embodiments of the present disclosure, the application server 104 can be installed in a virtual hosted environment providing application services. For example, these hosting technologies can include, but are not limited to, Azure, Amazon AWS, or other such service providers. Embodiments of the present disclosure are intended to include or otherwise cover any type of application server 104 hardware, including known, related art, and/or later developed technologies.

According to embodiments of the present disclosure, the processor 114 can be located on the application server 104. The processor 114 can be configured to execute the computer-readable instructions to generate an output relating to the system 100. According to embodiments of the present disclosure, the processor 114 can be, but is not limited to, a Programmable Logic Control (PLC) unit, a microprocessor, a development board, a controller, a microcontroller, and so forth. Embodiments of the present disclosure are intended to include or otherwise cover any type of the processor 114 including known, related art, and/or later developed technologies. Technologies supported by the processor are not limited to programming languages creating binary output or scripted processors such as, without limitation, python and bash.

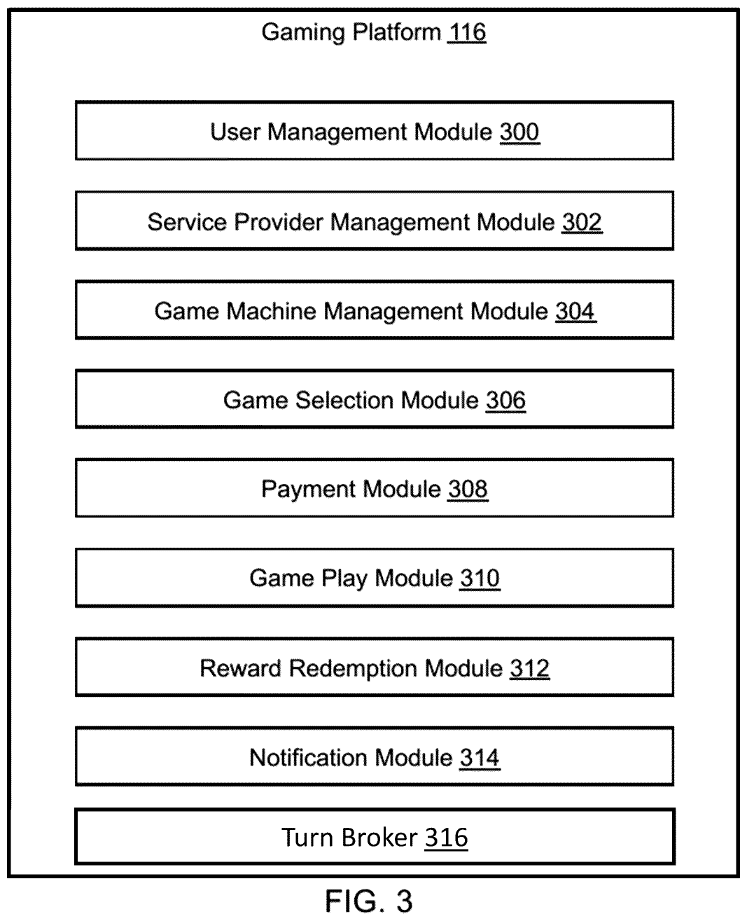

According to embodiments of the present disclosure, the gaming platform 116 can include a storage medium (not shown) configured to store the computer programmable instructions in form of programming modules. The storage medium of the gaming platform 116 can be a non-transitory storage medium, according to embodiments of the present disclosure. The gaming platform 116 can communicate with the processor 114 and execute a computer-readable set of instructions present in the storage medium, according to embodiments of the present disclosure. According to embodiments of the present disclosure, the storage medium of the gaming platform 116 can be, but is not limited to, a Random-Access Memory (RAM), a Static Random-access Memory (SRAM), a Dynamic Random-access Memory (DRAM), a Read Only Memory (ROM), an Erasable Programmable Read-only Memory (EPROM), an Electrically Erasable Programmable Read-only Memory (EEPROM), a NAND Flash, a Secure Digital (SD) memory, a cache memory, a Hard Disk Drive (HDD), a Solid-State Drive (SSD) and so forth. Embodiments of the present disclosure are intended to include or otherwise cover any type of the storage medium gaming platform 116, including known, related art, and/or later developed technologies. The gaming platform 116 can further be explained in connection with FIG. 3.

As described in greater detail in connection with FIG. 3, the gaming platform 116 can include a turn broker 316 configured to identify available game machines 106 and assign the available game machines 106 to the user. According to some embodiments, the turn broker 316 can also be configured to cooperate with one or more other modules of the gaming platform 116 (e.g., modules 300-314, described in connection with FIG. 3, to facilitate synchronized application controls and video streams to the user via the application 110.

According to embodiments of the present disclosure, the database 118 can be located on the application server 104. The database 118 can be adapted to be in communication with the processor 114 and the gaming platform 116, according to embodiments of the present disclosure. According to embodiments of the present disclosure, the database 118 can be configured to store user details provided by the user at the time of onboarding to the system 100. Embodiments of the present disclosure are intended to include or otherwise cover any user details that can be stored in the database 118, including known, related art, and/or later developed technologies.

According to embodiments of the present disclosure, the database 118 can further be configured to store details related to the activities of the user on the system 100. According to embodiments of the present disclosure, the details related to the activities of the user can be, but are not limited to, a number of balance coins in a wallet, a history of the game played, a scoreboard of the game played, details of rewards 124 won, details of rewards 124 redeemed, details of rewards 124 expired, details of rewards 124 shipped to the user, and so forth. Embodiments of the present disclosure are intended to include or otherwise cover any other details related to the activities of the user on the system 100 that can be stored in the database 118, including known, related art, and/or later developed technologies.

According to embodiments of the present disclosure, the database 118 can further be configured to store details related to the service provider on the system 100. According to embodiments of the present disclosure, the details related to the service provider can be, but are not limited to, a name of the service provide, a location of the service provider, a type of the game machine 106 provided by the service provider, and so forth. According to some embodiments of the present disclosure, the database 118 can comprise and/or be in communication with a timeseries database 118t, where collected telemetry data is stored. Embodiments of the present disclosure are intended to include or otherwise cover any details related to the service provider that can be stored in the database 118, including known, related art, and/or later developed technologies.

According to embodiments of the present disclosure, the database 118 can further be configured to store details related to the game machine 106 on the system 100. According to embodiments of the present disclosure, the details related to the game machine 106 can be, but are not limited to, a name of the game machine 106, a type of the game machine 106, a location for installation of the game machine 106, types of the rewards 124 rewarded by the game machine 106, and active timings of the game machine 106, and so forth. Embodiments of the present disclosure are intended to include or otherwise cover any details related to the game machine 106 that can be stored in the database 118, including known, related art, and/or later developed technologies.

According to embodiments of the present disclosure, the database 118 can be for example, but is not limited to, a distributed database, a personal database, an end-user database, a commercial database, a Structured Query Language (SQL) database, a non-SQL database, an operational database, a relational database, an object-oriented database, a graph database, a timeseries database, a cloud server database, and so forth. Embodiments of the present disclosure are intended to include or otherwise cover any type of the database 118 including known, related art, and/or later developed technologies.

Further, the database 118 can be a cloud server hosted database, according to embodiments of the present disclosure. According to embodiments of the present disclosure, the cloud server can be remotely located. According to further embodiments of the present disclosure, the cloud server can be a public cloud server or a private cloud server. In yet another embodiment of the present disclosure, the cloud server can be a dedicated cloud server. According to embodiments of the present disclosure, the cloud server can be, but is not limited to, a Microsoft Azure cloud server, an Amazon AWS cloud server, a Google Compute Engine (GEC) cloud server, an Amazon Elastic Compute Cloud (EC2) cloud server, and so forth. Embodiments of the present disclosure are intended to include or otherwise cover any type of the cloud server including known, related art, and/or later developed technologies.

In a further embodiment of the present disclosure, the system 100 can include a plurality of databases 118, however, as shown in FIG. 1, the system 100 can include a singularity of the database 118. In other examples, a single database can be modified to be considered a part of a service cluster where it can be accessed by multiple front end user interfaces (UIs).

According to some embodiments of the present disclosure, the communication module 119 can be in two-way communication with the network 108 and comprise hardware and/or software components for transmitting and/or receiving information to and/or from the application server 104 and other hardware and software components of system 100 (e.g., the user devices 102a-n and the game machines 106a-n). According to some embodiments of the present disclosure, the communication module 119 can comprise and/or be in communication with a reporting module 119r (e.g., for providing reporting from the SQL database and/or timeseries database 118t) and an AI endpoint management module 119x. The reporting module 119r can

According to further embodiments of the present disclosure, the AI endpoint management module 119x routinely tests endpoints and network status for errors and outages. The AI endpoint management module 119x can also make endpoints active and inactive depending on the results from the tests. The AI endpoint management module 119x can be hosted on Linux/Unix OS, Windows OS, or another OS. According some non-limiting examples, the AI endpoint management module 119x can comprise Unix bash scripts, Java tomcat services, and/or binaries running on the server 104 of system 100. Using the bash scripts as an execution platform, all nodes on the network 108 receive commands using Secure Shell (SSH) to perform updates and or modifications to the individual nodes using parameters retrieved from each respective host. According to such examples an Apache Tomcat server can handle API requests and business logic. Additionally, notifications and other actions can be performed from compiled binaries published to the server 104.

According to embodiments of the present disclosure, the game machine 106 can include media streaming units 120a-120n (hereinafter individually referred to as the “media streaming unit 120”), game controlling units 122a-122n (hereinafter individually referred to as the “game controlling unit 122”), rewards 124a-124n (hereinafter individually referred to as the “rewards 124”), and identification tags 126a-126n (hereinafter individually referred to as the “identification tag 126”).

According to embodiments of the present disclosure, the game machine 106 can be utilized by the user for remotely playing the arcade game using the user device 102. The game machine 106 can be installed and/or located at a remote location relative to the user device 102, according to embodiments of the present disclosure.

According to embodiments of the present disclosure, the game machine 106 can be represented by a status of the game machine 106 According to embodiments of the present disclosure, the status of the game machine 106 can be, but is not limited to, an unavailable status, an available status, a waiting status, and so forth. Embodiments of the present disclosure are intended to include or otherwise cover any status of the game machine 106, including known, related art, and/or later developed technologies.

According to embodiments of the present disclosure, the unavailable status of the game machine 106 can denote that the game machine 106 is not operational, and therefore the user can not remotely play the selected arcade game on the corresponding game machine 106 having the unavailable status. The available status of the game machine 106 can denote that the game machine 106 is in operation, and therefore the user can remotely play the selected arcade game on the corresponding game machine 106 having the available status. Further, the waiting status of the game machine 106 can denote that the game machine 106 is in the operation status, however, another user may be remotely or physically playing the selected arcade game on the corresponding game machine 106 having the waiting status. The game machine 106 can be in the waiting status while another user is playing the selected arcade game on the corresponding game machine 106, either remotely using the user device 102 or locally by interacting and operating the corresponding game machine 106 physically.

According to embodiments of the present disclosure, the arcade game that can be played by the user on the game machine 106 can be, but is not limited to, an electronic claw, a fantastic prize, a ton of tickets, a big one extreme II, a mini-Taj Mahal, a tower of tickets, a wizard of oz, a willy Wonka, a flintstones quarry quest, a quick drop, a fishbowl frenzy, pop the lock, a monopoly, a pearl fishery, and so forth. Embodiments of the present disclosure are intended to include or otherwise cover any game that can be played by the user on the game machine 106, including known, related art, and/or later developed technologies.

According to embodiments of the present disclosure, the remote location for the installation of the game machine 106 can include, but is not limited to, a shopping mall, an arcade gaming parlor, a warehouse, a home, a community center, and so forth. Embodiments of the present disclosure are intended to include or otherwise cover any remote location for the installation of the game machine 106, including known, related art, and/or later developed technologies that can enable the user to play the game from the remote location using the communication network 108.

According to embodiments of the present disclosure, the game machine 106 can be, but is not limited to, a mechanical game machine, an electronic game machine, a digital game machine, a multiplayer game machine, and so forth. Moreover, the game machine 106 can include any physical interactive device or system having local user controls, which provides visual and/or audible feedback to a user, without departing from the spirit and scope of the present disclosure. Embodiments of the present disclosure are intended to include or otherwise cover any type of the game machine 106, including known, related art, and/or later developed technologies.

The media streaming unit 120 can be configured to telecast and/or live stream the arcade game being played by the user on the game machine 106 to the user device 102, according to embodiments of the present disclosure. According to embodiments of the present disclosure, the telecasted and/or live-streamed feed can contain either audio and video or only video of the arcade game being played by the user on the game machine 106. The user can play and control the arcade game based on the telecasted and/or live-streamed feed from the media streaming unit 120, according to embodiments of the present disclosure. According to embodiments of the present disclosure, a plurality of media streaming units 120 can be arranged to capture the game machine 106 from a plurality of different views and/or angles. For example, a first media streaming unit 120 can be positioned to capture a first (e.g., front perspective) view of the game machine 106 and a second media streaming unit 120 can be positioned to capture a second (e.g., side perspective) view of the game machine 106. According to embodiments of the present disclosure, the media streaming units 120 can be positioned outside of a housing of the game machine 106. Furthermore, the media streaming units 120 can be free-standing (e.g., positioned on tripods or the like) or can be secured to an exterior of the game machine 106 (e.g., attached to the housing of the game machine 106 via a bracket or other similar hardware). The gaming application 110 can further enable the user to switch and/or orient between the various media streaming units 120 to view the game machine 106 from various different views and/or angles, according to embodiments of the present disclosure. The gaming application 110 can further enable the user to move the media streaming unit 120 using pan, tilt, and/or other motion control commands to position the media streaming unit 120 in the desired orientation or field of view, based on user input via user interface elements of the gaming application. According to other aspects of the present disclosure, gaming application 110 of the user device 102 and/or a game controlling unit 122, discussed herein, can automatically control the orientation or field of view of the media streaming unit 120 based on gameplay.

According to embodiments of the present disclosure, while playing the game, the user can observe the game machine 106 telecasted and/or live-streamed by the media streaming unit 120 by rotating and/or by swiping or by otherwise entering input on the display unit of the user device 102. In another embodiment of the present disclosure, the user can utilize the input means of the user device 102 to rotate, or cycle through, one or more views of the game machine 106 provided by the media streaming unit 120.

According to the other embodiments of the present disclosure, the media streaming unit 120 can be, but is not limited to, a still camera, a video camera, a color balancer camera, a thermal camera, an infrared camera, a telephoto camera, a wide-angle camera, a macro camera, a Close-Circuit Television (CCTV) camera, a web camera, an action camera, a motor controlled chassis configured to pan, tilt, or otherwise reposition the camera, and so forth. The media streaming unit 120 can also include a wired (e.g., ethernet) or wireless (e.g., Wi-Fi) network communication interface configured for communication with the communication network 108. According to some embodiments of the present disclosure, the media streaming unit 120 can be an Internet of Things (IoT) based camera. Embodiments of the present disclosure are intended to include or otherwise cover any type of the media streaming unit 120, including known, related art, and/or later developed technologies.

According to embodiments of the present disclosure, the media streaming unit 120 can be installed and/or arranged in, on, or around the game machine 106 using attachment means. According to embodiments of the present disclosure, the attachment means can include, but is not limited to, a rack mount, a tripod, a platform, an inverted hanger, a side mount, and so forth. Embodiments of the present disclosure are intended to include or otherwise cover any attachment means for attaching the media streaming unit 120 inside the game machine 106, including known, related art, and/or later developed technologies.

According to embodiments of the present disclosure, the game controlling unit 122 can be installed in the game machine 106. The game controlling unit 122 can be configured to receive inputs from the user device 102, via the communication network 108, to remotely control the game machine 106, according to embodiments of the present disclosure. According to embodiments of the present disclosure, the game controlling unit 122 can be configured to remotely control the game machine 106 by translating a received input digital or analog signal into a digital or analog signal output (e.g., a control signal) that can further be provided to the game machine 106 for control thereof. Similarly, the game controlling unit 122 can be configured to receive digital or analog output signals from the game machine 106 and translate the digital or analog output signals for transmission to the user device 102 via the network 108.

According to some embodiments of the present disclosure, the game machine 106 can be an existing game machine and the game controlling unit 122 can be electronically coupled to the game machine 106, thereby enabling remote gameplay and control of the existing game machine 106. According to such embodiments, the game machine 106 can include a controller with one or more inputs which receive signals or commands from one or more input devices of the game machine 106 (e.g., buttons, joysticks, etc.) and one or more outputs which provide gameplay signals or commands to one or more other components of the game machine 106 which execute the gameplay commands (e.g., motors, lights, speakers, displays, thrusting air or vacuum controls, etc.). Additionally, the output signals of the game controlling unit 122 can be electronically coupled to the inputs of the game machine 106 controller. Accordingly, those of ordinary skill in the art will understand the game controlling unit 122 can be configured to remotely control the game machine 106 by translating the received user input signal into an output signal which is electronically coupled to the inputs of the game machine 106 controller, such that the game machine 106 controller controls the other components of the game machine 106 which execute the gameplay commands. In this way, the game machine 106 can be controlled locally (e.g., via input devices of the game machine 106) or remotely by the game controlling unit 122.

According to embodiments of the present disclosure, the received user input signals can denote real-time actions that can be performed remotely by the game machine 106, the real-time machine actions including, but not limited to, a rotatory action, a revolving action, a sliding action, a swiping action, a flicking action, a pulling action, a pushing action, a picking action, a dropping action, and so forth. Embodiments of the present disclosure are intended to include or otherwise cover any action that can be performed remotely by the game machine 106 upon receipt of the input digital signal from the user device 102, including known, related art, and/or later developed technologies.

As discussed herein, the output signal generated by the game controlling unit 122 can further activate and control components of the game machine 106, according to embodiments of the present disclosure. According to embodiments of the present disclosure, the components of the game machine 106 that can be controlled by the game controlling unit 122 can include for example, but are not limited to, stepper motors, servo motors, relays, resistors, rectifiers, and so forth. Embodiments of the present disclosure are intended to include or otherwise cover any component of the game machine 106 that can be controlled by the game controlling unit 122, including known, related art, and/or later developed technologies. According to embodiments of the present disclosure, the game controlling unit 122 can be, but is not limited to a Programmable Logic Control (PLC) unit, a microprocessor, a development board, a controller, a microcontroller, and so forth. According to one non-limiting example, the game controlling unit 122 can be a Raspberry Pi having one or more optical, digital, and/or analog input and/or output modules. Embodiments of the present disclosure are intended to include or otherwise cover any type of the game controlling unit 122 including known, related art, and/or later developed technologies.

According to embodiments of the present disclosure, the actions performed by the user on the user device 102 through the user interface 112 of the gaming application 110 can be transmitted to the remote game machines 106 in real-time. The actions from the user device 102 act as the (e.g., digital) input signals that can be received by the game controlling unit 122. According to embodiments of the present disclosure, upon receipt of the user input signal that can be received by the game controlling unit 122, the input signal can further be translated into the (e.g., digital or analog) output signal that can further be fed to the components of the game machine 106, according to embodiments of the present disclosure.

According to embodiments of the present disclosure, the actions performed on the game machine 106 by the output signal can be telecasted and/or live streamed onto the user interface 112 of the gaming application 110 installed in the user device 102, that can provide user a feeling of playing the arcade game at a physical location of the installation of the game machine 106.

According to one example, if the user remotely operates the input means to drive an electronic claw in the remotely installed game machines 106 in a forward direction, then the input signal denoting a forward movement of the electronic claw can be transmitted from the user device 102 to the game machines 106 via the game controlling unit 122 in the real-time. The received input signal denoting the forward movement of the electronic claw can be translated into the output signal by the game controlling unit 122 which can further be used to drive the electronic claw in a forward direction.

According to another example, if the user remotely operates the input means to drop the electronic claw of the remotely installed game machines 106, then the input signal denoting a drop movement of the electronic claw can be transmitted from the user device 102 to the game machines 106 in the real-time. The received input signal denoting the drop movement of the electronic claw can be translated into the output signal by the game controlling unit 122 which can further be used to drive the electronic claw in a downward direction. Similarly, other movements of the electronic claw can be governed from the user device 102 to be translated by the game controlling unit 122 to perform the corresponding actions over the game machines 106.

According to embodiments of the present disclosure, the media streaming unit 120 can be arranged surrounding the game machine 106 to telecast and/or live stream the arcade game being played by the corresponding user on the corresponding game machine 106 to the corresponding user device 102.

According to embodiments of the present disclosure, the rewards 124 can be stored in the game machine 106 and/or can be disbursed to the user upon winning the arcade game played by the user. According to embodiments of the present disclosure, the rewards 124 can be positioned within the game machine 106 through an inlet (not shown) by the service provider. Further, upon winning, the rewards 124 can be dispensed from the game machine 106 into a reward drop area (not shown), which can further be collected into a bin (not shown), according to embodiments of the present disclosure. According to embodiments of the present disclosure, the inlet, the reward drop area, and the bin can be the part of the game machine 106.

According to embodiments of the present disclosure, the reward 124 can be a physical reward, a digital reward or a combination thereof. According to embodiments of the present disclosure, the rewards 124 can be, but are not limited to, a soft toy, a plushie, an electronic toy, amusement park tickets, discount vouchers, gift cards, points, reward coins, and so forth. Embodiments of the present disclosure are intended to include or otherwise cover any rewards 124 that can be stored in the game machine 106 and can further be dispensed upon winning the arcade game played by the user, including known, related art, and/or later developed technologies.

According to embodiments of the present disclosure, the identification tag 126 can be embedded into the rewards 124 with a fastening means. The identification tag 126 can help identification of the specific rewards 124 won by the corresponding user, according to embodiments of the present disclosure. According to embodiments of the present disclosure, the identification tag 126 can be removed before shipping the rewards 124 to the postal address of the user.

In another embodiment of the present disclosure, a counter part of the identification tag 126 can be communicatively connected to the game controlling unit 122 and arranged over the reward drop area. The counter part of the identification tag 126 can generate an electronic flux of a predefined frequency, according to embodiments of the present disclosure. According to embodiments of the present disclosure, as the rewards 124 with identification tag 126 can be passed through the electronic flux, the electronic flux can be disturbed. The amount of disturbance in the electronic flux can lead to the identification of the identification tag 126, according to embodiments of the present disclosure. According to embodiments of the present disclosure, the identification tag 126 embedded within the rewards 124 can lead to recognition of the selected rewards 124 won by the corresponding user.

According to embodiments of the present disclosure, the identification tag 126 can be of any type generating the electronic flux of any frequency such as, but not limited to, a millimeter waves tag, a Quick Recognition (QR) tag, a bar code tag, and so forth. In some embodiments of the present disclosure, the identification tag 126 can be a Radio Frequency Identification (RFID) tag generating the electronic flux of 915 Megahertz (MHz) in a traveling wave antenna, or 125 Kilohertz (MHz) in a flat mount antenna. According to one non-limiting example, an RFID reader is positioned in or on the game machine and electronically coupled to the game controlling unit 122 (e.g., a Raspberry Pi device) and the system 100 poles the RFID reader for RFID tags that are read as they pass the RFID reader. A read RFID tag ID can then be compared to a predefined table of RFID tag IDs and prize values to determine the value of the prize. Additionally, and RFID tag ID writer is configured to associate RFID tags with the proper ID, so they can be identified by the game logic of system 100. Embodiments of the present disclosure are intended to include or otherwise cover any type of the identification tag 126 that can generate the electronic flux of any frequency, including known, related art, and/or later developed technologies.

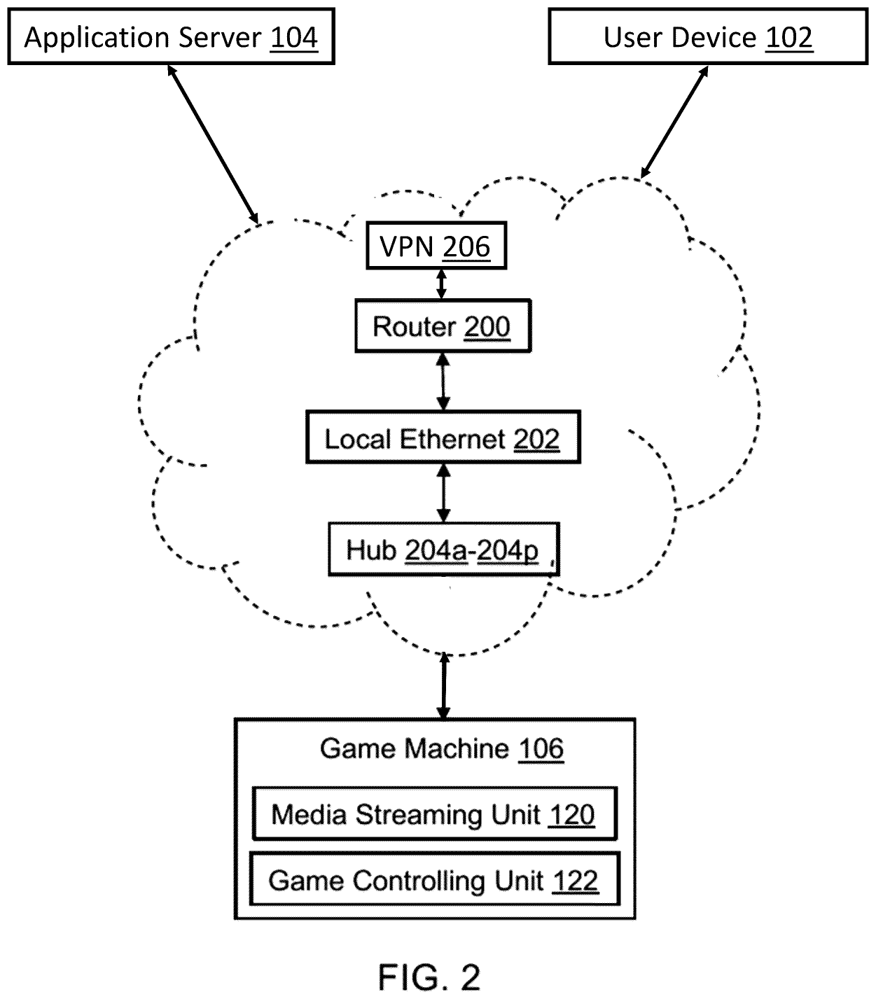

The communication network 108 can include a data network such as, but not limited to, the Internet, Local Area Network (LAN), Wide Area Network (WAN), Metropolitan Area Network (MAN), etc. In some embodiments of the present disclosure, the communication network 108 can include a wireless network, such as, but not limited to, a cellular network that can employ various technologies including an Enhanced Data Rates For Global Evolution (EDGE), a General Packet Radio Service (GPRS), etc. or a non-cellular network that can employ various technologies including a Wireless Fidelity (Wi-Fi), a Light Fidelity (Li-Fi), a Bluetooth, long-range millimeter (mm) waves, etc. In some embodiments of the present disclosure, the communication network 108 can include or otherwise cover networks or sub-networks, each of which can include, for example, a wired or a wireless data pathway. Examples of the communication network 108 can further include, but are not limited to, a Personal Area Network (PAN), a Storage Area Network (SAN), a Home Area Network (HAN), a Campus Area Network (CAN), a Virtual Private Network (VPN), an Enterprise Private Network (EPN), Internet, a Global Area Network (GAN), and so forth. Embodiments of the present disclosure are intended to include or otherwise cover any type of network, including known, related art, and/or later developed technologies to connect components of the system 100. According to an embodiment of the present disclosure, the user device 102, the application server 104, and the game machine 106 can be configured to communicate with each other by one or more communication mediums connected to the communication network 108. The communications mediums include, but are not limited to, a twisted pair cable, a coaxial cable, a copper wire, a fiber optic, and so forth. Embodiments of the present disclosure are intended to include or otherwise cover any type of communication medium, including known, related art, and/or later developed technologies. The communication network 108 is further explained in connection with FIG. 2.

FIG. 2 is a block diagram depicting an internal arrangement of the components of the communication network 108 of the system 100, according to embodiments of the present disclosure. According to embodiments of the present disclosure, the communication network 108 can include a router 200, a local ethernet 202, and hubs 204a-204p (hereinafter individually referred to as the “communication hub 204”). According to some embodiments of the present disclosure, the network 108 can further include a VPN 206, for example an Azure VPN.

According to an embodiment of the present disclosure, the user device 102, the application server 104, and the game machine 106 can be configured to communicate with each other via the communication network 108. According to embodiments of the present disclosure, the router 200 can be configured to route and transmit the received input digital signal from the corresponding user device 102 through the Internet to the specified game machine 106 using the local ethernet 202 via the communication hub 204.

According to embodiments of the present disclosure, a live Internet connectivity can be fed into the router 200. The router 200 can further be connected to the local ethernet 202, according to embodiments of the present disclosure. According to embodiments of the present disclosure, the local ethernet 202 can provide a backbone to the communication network 108.

According to embodiments of the present disclosure, the communication hub 204 can be configured to provide a point of contact to one or more of the game machines 106 installed at a specified location. The communication hub 204 with the game machine 106 attached at ports can be connected to the local ethernet 202, according to embodiments of the present disclosure.

According to embodiments of the present disclosure, the router 200 can include, but is not limited to, a wired router, a wireless router, a core router, an edge router, a Virtual Private Network (VPN) router, and so forth. Embodiments of the present disclosure are intended to include or otherwise cover any type of the router 200, including known, related art, and/or later developed technologies. In a preferred embodiment of the present disclosure, the local ethernet 202 can be supplied using an ethernet cable. According to embodiments of the present disclosure, the ethernet cable used in the local ethernet 202 can include, but is not limited to, a cat 3 ethernet cable, a cat 5 ethernet cable, a cat 5E ethernet cable, a cat 6 ethernet cable, a cat 6A ethernet cable, a cat 7 ethernet cable, a cat 8 ethernet cable, and so forth. Embodiments of the present disclosure are intended to include or otherwise cover any type of the ethernet cable used in the local ethernet 202, including known, related art, and/or later developed technologies. According to embodiments of the present disclosure, the communication hub 204 can include, but is not limited to, an active hub, a passive hub, an intelligent hub, switches, sfps, controller cards, memory and so forth. Embodiments of the present disclosure are intended to include or otherwise cover any type of the communication hub 204, including known, related art, and/or later developed technologies. The VPN 206 can connect to a hosted environment (e.g., Microsoft Azure) and to one or more of the server 104, the user devices 102a-n, and the game machines 106a-n using encryption and VPN protocols provide.

FIG. 3 is a block diagram depicting components of the gaming platform 116 of the system 100, according to embodiments of the present disclosure. The gaming platform 116 can include, but is not limited to, a user management module 300, a service provider management module 302, a game machine management module 304, a game selection module 306, a payment module 308, a game play module 310, a reward redemption module 312, a notification module 314, and a turn broker 316.

According to embodiments of the present disclosure, the user management module 300 can be configured to enable the onboarding of a new user by registering the user on the system 100 with pre-defined details. According to embodiments of the present disclosure, the pre-defined details of the user can be, but are not limited to, the name of the user, the age of the user, the gender of the user, the address and the postal code of the user, the interest of the user, the username of the user, the credential of the user, the phone number of the user, the electronic mail of the user, and so forth. Embodiments of the present disclosure are intended to include or otherwise cover any pre-defined details of the user, including known, related art, and/or later developed technologies.

In another embodiment of the present disclosure, the pre-defined details of the user can be automatically fetched from open access accounts, social media accounts, electronic mail accounts, device-based login system, and so forth. In an embodiment of the present disclosure, the open access accounts, the social media accounts, the electronic mail accounts, or the device-based login system can be services from Google, Facebook, Twitter, Apple, and so forth.

According to embodiments of the present disclosure, the credentials of the user can be biometric credentials. According to embodiments of the present disclosure, the biometric credentials can include, but are not limited to, a fingerprint of the user, an iris of the user, a face of the user, a vocal sample of the user, and so forth. Embodiments of the present disclosure are intended to include or otherwise cover any type of the biometric credentials that can be provided by the user, including known, related art, and/or later developed technologies. In another embodiment of the present disclosure, the credentials of the user can be a character credential. According to embodiments of the present disclosure, the username of the user and the character credential of the user can be a series of characters. According to embodiments of the present disclosure, the character can be, but is not limited to, an alphabetical character, a numerical character, a special character, and so forth. Embodiments of the present disclosure are intended to include or otherwise cover any type and any number of characters in the username of the user and the character credential of the user, including known, related art, and/or later developed technologies.

The user management module 300 can further be configured to generate an avatar of the user, according to embodiments of the present disclosure. The avatar can be a face-only avatar, according to embodiments of the present disclosure. In another embodiment of the present disclosure, the avatar can be a full-body avatar. The avatar can be automatically generated by capturing an image of the user and translating the same captured image into the avatar, according to embodiments of the present disclosure. In another embodiment of the present disclosure, the avatar can be manually generated by the user by selecting various facial features that can be represented on the avatar. According to embodiments of the present disclosure, the various facial features can include, but are not limited to, eyes of the avatar, ears of the avatar, a nose of the avatar, a mouth of the avatar, a face shape of the avatar, a face complexion of the avatar, an eye color of the avatar, and so forth. Embodiments of the present disclosure are intended to include or otherwise cover any facial features that can be represented on the avatar, including known, related art, and/or later developed technologies. According to embodiments of the present disclosure, the avatar and the pre-defined details of the user can be stored in the database 118 under the corresponding user.

According to embodiments of the present disclosure, the user management module 300 can further be configured to generate a profile of the user by using the user details, and avatar of the user.

Further, after successful generation and activation of the username of the user and the credentials of the user, the user management module 300 can enable the user to log into the gaming application 110 using the username and the credentials, according to embodiments of the present disclosure. According to embodiments of the present disclosure, after a successful login process, the user can be presented with the user interface 112. However, upon an unsuccessful login process, the user can be presented with an error message, according to embodiments of the present disclosure. According to embodiments of the present disclosure, the user management module 300 can be configured to enable the user to recover lost and/or forgotten credentials.

Further, upon successful login process of the user, the user management module 300 can be configured to transmit a session initialization signal to the game selection module 306.

According to embodiments of the present disclosure, the service provider management module 302 can be configured to enable the onboarding of a new service provider by receiving and/or providing pre-set details of the service provider. According to embodiments of the present disclosure, the pre-set details of the service provider can be, but are not limited to, a location of the service provider, a type of game machine 106 provided by the service provider, types of services offered by the service provider, a type of rewards offered by the service provider, and so forth. Embodiments of the present disclosure are intended to include or otherwise cover any pre-set details of the service provider, including known, related art, and/or later developed technologies. According to embodiments of the present disclosure, the pre-set details of the service provider can be stored in the database 118 under the corresponding service provider. In another embodiment of the present disclosure, the service provider can be enabled to change the coins required for playing of the arcade games in real-time.

According to embodiments of the present disclosure, the game machine management module 304 can be configured to enable management of the game machine 106 by storing information related to the game machine 106 in the database 118. According to embodiments of the present disclosure, the information related to the game machine 106 can be, but is not limited to, a name of the game machine 106, a type of the game machine 106, a location for installation of the game machine 106, types of the rewards rewarded by the game machine 106, an active timings of the game machine 106, a current status of the game machine 106, e.g., available, queued, unavailable, and so forth. Embodiments of the present disclosure are intended to include or otherwise cover any information related to the game machine 106, including known, related art, and/or later developed technologies.

According to embodiments of the present disclosure, the game selection module 306 can be configured to be activated upon receipt of a session initialization signal from the user management module 300. The game selection module 306 can be configured to enable the user to select the arcade game to be played from a catalog of arcade games, according to embodiments of the present disclosure. According to embodiments of the present disclosure, the catalog of the arcade games can contain categories such as, but not limited to, claw games, coin pusher games, other arcade games, and so forth. Embodiments of the present disclosure are intended to include or otherwise cover any category of the arcade game that can be present in the catalog of the arcade games, including known, related art, and/or later developed technologies. According to embodiments of the present disclosure, the arcade games in the catalog of the arcade games can be, but are not limited to, the electronic claw, the fantastic prize, the tons of tickets, the big one extreme II, the mini-Taj Mahal, the tower of tickets, the wizard of oz, the willy Wonka, the flintstones quarry quest, the quick drop, the fishbowl frenzy, the pop the lock, the monopoly, the pearl fishery, and so forth. Embodiments of the present disclosure are intended to include or otherwise cover any arcade games in the catalog of the arcade games, including known, related art, and/or later developed technologies.

Further, upon selection of the arcade game to be played from the catalog of the arcade games, in some embodiments the game selection module 306 can be configured to enable the user to play a demonstration game of the selected game, according to embodiments of the present disclosure. For example, first-time players can be provided with an opportunity to play the selected game (e.g., the demonstration game), without requiring payment, on a limited basis. According to some embodiments of the present disclosure, the user can be provided with an opportunity to play the demonstration game a predetermined number of times (e.g., 1, 2, 3, etc. plays) before payment is required. Alternatively, and/or additionally, the user can be provided with an opportunity to play the demonstration game for a predetermined amount of time (e.g., 1, 5, 10, etc. minutes) before payment is required. According to further embodiments of the present disclosure, it can be a choice of the user to participate in the demonstration game. If the user selects not to play the demonstration game of the selected game, then the game selection module 306 can be configured to transmit an activation signal to the payment module 308, according to embodiments of the present disclosure. However, if the user selects to play the demonstration game, then the game selection module 306 can be configured to transmit a demonstration game play signal to the game play module 310 and a first notification signal to the notification module 314.

According to embodiments of the present disclosure, the payment module 308 can be configured to include a 1 time only purchase of a higher than normal value package/coin/token to be determined by other processes and methods described in this application. According to additional embodiments of the present disclosure, the payment module 308 can be configured to be activated upon receipt of the activation signal from the game selection module 306. The payment module 308 can be configured to compare the coins in the wallet of the user with the coins required for playing the selected game, according to embodiments of the present disclosure. According to embodiments of the present disclosure, upon comparison, in case the coins in the wallet of the user are greater than or equal to the coins required for playing the selected game, then the payment module 308 can transmit a game play signal to the game play module 310. If the coins in the wallet of the user are less than the coins required for playing the selected game, then the payment module 308 can be configured to transmit a second notification signal to the notification module 314, according to embodiments of the present disclosure. Along with the second notification signal transmitted to the notification module 314, the payment module 308 can be configured to enable the user to recharge the coin wallet by utilization of a real currency, according to embodiments of the present disclosure. According to embodiments of the present disclosure, the payment module 308 can redirect the user to a payment gateway where the real currency can be traded for coins using a payment method. The payment module 308 can further be configured to allow the user to select the payment method of their choice as per their convenience, according to embodiments of the present disclosure.

According to embodiments of the present disclosure, the payment module 308 can provide a choice of preset packages for the coins that can enable the user to quickly recharge the coin wallet by utilization of real currency. The payment module 308 can provide an option enabling the user to input an amount of the real currency, that the user can want to spend recharging the wallet with the coins, or the payment module 308 can further be configured to provide another option enabling the user to input a number of the coins that the user can desire to credit in the wallet using the payment method, according to embodiments of the present disclosure. According to embodiments of the present disclosure, the payment method available on the payment gateway for purchasing the coins can be, but is not limited to, a credit card, a debit card, an internet banking service, a mobile payment method, and so forth. Embodiments of the present disclosure are intended to include or otherwise cover any payment method available on the payment gateway for purchasing the coins, including known, related art, and/or later developed technologies.

Upon successful recharge of the wallet with the coins, the payment module 308 can further be configured to compare the total coins in the wallet of the user with the coins required for playing the selected game, according to embodiments of the present disclosure. If the coins in the wallet of the user are greater than or equal to the coins required for playing the selected game, then the payment module 308 can be configured to transmit the game play signal to the game play module 310. Otherwise, the payment module 308 can be configured to enable the user to attempt to recharge the wallet again, according to embodiments of the present disclosure. In another embodiment of the present disclosure, the payment module 308 can be configured to enable the user to use the previously won rewards to convert them into the coins in order to play the selected game.

According to embodiments of the present disclosure, the turn broker 316 is configured to identify available game machines 106 and assign available game machines 106 to the user. In some embodiments, the turn broker 316 can be a Unix-based server configured with an open source package, for example and without limitation, a customized Janus package and database. As shown, the turn broker 316 may be part of the gaming platform 116 and in some examples may be comprise a standalone computing platform. The turn broker 316 can also be configured to cooperate with one or more of the modules 300-314 of the gaming platform 116 to facilitate synchronized application controls and video streams to the user via the application 110.

According to embodiments of the present disclosure, the game play module 310 can be configured to be activated upon receipt of the demonstration game play signal from the game selection module 306. If activated from the demonstration game play signal, the game play module 310 can be configured to enable the user to play the demonstration game of the selected game, according to embodiments of the present disclosure. According to embodiments of the present disclosure, the game play module 310 can prohibit winning rewards while playing the demonstration game. The game play module 310 can further be configured to restrict a number of attempts for which the user can play the demonstration game, according to embodiments of the present disclosure. In another embodiment of the present disclosure, the game play module 310 can be configured to bind the demonstration game for a specified duration. Post expiration of the specified duration, the game play module 310 can enable the user to either play the selected game or play again the demonstration game of the selected game, according to embodiments of the present disclosure. According to embodiments of the present disclosure, if the user can have exhausted all the attempts of the demonstration game, then the game play module 310 can be configured to enable the user to either play the selected game or select any other arcade game to be played from the catalog of arcade games using the game selection module 306. Accordingly, in some examples the game play module 310 may communicate with the turn broker 316 to determine if a game is available to play (e.g., the game machine 106 is operational and/or not currently in use by or queued by another user device 102).

In another embodiment of the present disclosure, the game play module 310 can further be configured to be activated upon receipt of the game play signal from the payment module 308. If activated from the game play signal, the game play module 310 can be configured to enable the user to play the selected game, according to embodiments of the present disclosure. According to embodiments of the present disclosure, the game play module 310 can be configured to allow the winning of rewards when playing the selected game.

Further, the game play module 310 can be configured to check a status of the game machine 106 corresponding to the game selected by the user. In some examples, the game play module 310 may be configured to communicate with the turn broker 316 to determine the status of a game machine 106. Upon checking, if the status of the game machine 106 is “available,” then the game play module 310 can be configured to enable the user to play the selected game on the corresponding game machine 106. However, in case the status of the game machine 106 is “unavailable,” then the game play module 310 can transmit a third notification signal to the notification module 314 and can ask the user to wait for a turn to play the selected game. Additionally, the game play module 310 can transmit a third notification signal to the notification module 314 and can notify the user of the play status and provide links to actions that are but not limited to game states, according to embodiments of the present disclosure. Once, the status of the corresponding game machine 106 is “available” the game play module 310 can then be configured to transmit a fourth notification signal to the notification module 314. As the status of the corresponding game machine 106 is “available,” the game play module 310 can enable the waiting user to play the selected game on the corresponding game machine 106, according to embodiments of the present disclosure.

According to embodiments of the present disclosure, the game play module 310 can further activate the media streaming unit 120 for telecasting and/or live streaming a real time video and/or audio of an environment of the game machine 106 to user device 102. The user can play the selected game using the user device 102 remotely, by watching and/or by hearing the telecasted and/or live streamed the real time video and/or audio of the environment of the game machine 106, according to embodiments of the present disclosure. In some examples, in response to periodic automatic and/or manually initiated communications between the game play module 310, the game controlling unit 122 may be activated (e.g., in response to signals from the user device 102) and the media streaming unit 120 can start streaming video and images of the game machine 106.

Post completion of the selected game played on the corresponding game machine 106, the game play module 310 can be configured to declare a result, according to embodiments of the present disclosure. According to embodiments of the present disclosure, the result can be declared based on the end goal met in the pre-defined time. The result of the selected game played can be either a winning result or a losing result, according to embodiments of the present disclosure.

According to embodiments of the present disclosure, if the result of the user post completion of the selected game played can be the winning result, then the game play module 310 can be configured to provide the user with a choice, either to replay the game or redeem rewards. If the user selects to replay the game, then the game play module 310 can be configured to activate the game selection module 306. Otherwise, the user can select to redeem rewards, which can further transmit a reward redemption signal to the reward redemption module 312.

In another embodiment of the present disclosure, if the result of the selected game played can be the losing result, then the game play module 310 can be configured to provide the user with a choice, either to replay the selected game or select other game. If the user selects to replay the game, then the game play module 310 can be configured to activate the game selection module 306. Otherwise, the user can select to replay the selected game, leading the payment module 308 to again check the balance of the coins in the wallet of the user.

According to embodiments of the present disclosure, the game play module 310 can further provide information related to the selected game play such as, but not limited to, the name of the game, a time of game play, a date of game play, a result of game play, the rewards 124 of game play, and so forth. Embodiments of the present disclosure are intended to include or otherwise cover any information related to the selected game play that can be provided by the game play module 310, including known, related art, and/or later developed technologies.

According to embodiments of the present disclosure, the reward redemption module 312 can be configured to be activated upon receipt of the reward redemption signal from the game play module 310. The reward redemption module 312 can be configured to enable the user to redeem the rewards won after receiving the winning result of the selected game for the corresponding user, according to embodiments of the present disclosure. According to embodiments of the present disclosure, the reward redemption module 312 can be configured to enable the user to select rewards to be redeemed from a reward catalog.

According to embodiments of the present disclosure, the reward redemption module 312 can further enable the user to either choose the selected rewards in a physical manner to ship to the address and the postal code of the user or redeem the selected rewards for coins that can be credited into the wallet of the user. For example, if the user won the reward of a teddy bear, then the reward redemption module 312 can provide an option for shipping the reward of the teddy bear to the address and the postal code of the user. The reward redemption module 312 can further provide an option for redeeming the reward of the teddy bear into an equivalent number of coins. The equivalent number of coins can be a predetermined value of the coins that are associated with the rewards. For example, if the predetermined value of the coins associated with the teddy bear is 30 coins, then the reward redemption module 312 can be configured to enable the user to redeem the reward of the teddy for 30 coins that can further be credited into the wallet of the user.

The reward redemption module 312 can be configured to provide a coin expiry timer to the user, according to embodiments of the present disclosure. For example, the user can be able to redeem the rewards for coins only when the coin expiry timer has not ended or expired. According to embodiments of the present disclosure, the reward redemption module 312 can be configured to transmit a fifth notification to the user device 102 before the coin expiry timer ends. Post-expiration of the coin expiry timer, the user can be left with the option to redeem the rewards in the physical manner (e.g., to ship at the address and the postal code of the user), according to embodiments of the present disclosure.

According to embodiments of the present disclosure, the reward redemption module 312 can further be configured to compute a reward expiry timer. For example, the user can be able to redeem the rewards in the physical manner only when the reward expiry timer has not expired or ended. According to embodiments of the present disclosure, the reward redemption module 312 can be configured to transmit a sixth notification to the user device 102 before the reward expiry timer ends. Post-expiration of the reward expiry timer, the user can be left with both the option to redeem the rewards in the physical manner (e.g., to ship at the address and the postal code of the user) or to redeem the rewards for coins that can be credited into the wallet of the user, according to embodiments of the present disclosure.

According to embodiments of the present disclosure, the reward redemption module 312 can be configured to enable the user to view a history of a total rewards won. The total rewards won can include the rewards that can be redeemed in the physical manner that can be shipped to the address and the postal code of the user, the rewards that can be redeemed for coins that can be credited into the wallet of the user, and the rewards that can have lapsed and/or expired, according to embodiments of the present disclosure.

According to embodiments of the present disclosure, the reward redemption module 312 can further provide additional details related to the rewards won. The additional details related to the rewards won can include, but are not limited to, the name of the reward won, the time of the reward won, the date of the reward won, the dimension of the reward won, the weight of the reward won, the time left for redeeming the reward won in the wallet as the coins, and so forth. Embodiments of the present disclosure are intended to include or otherwise cover any additional details related to the rewards won that can be provided by the reward redemption module 312, including known, related art, and/or later developed technologies.

In another embodiment of the present disclosure, the reward redemption module 312 can further be configured to provide additional details related to the rewards redeemed in the physical manner. The additional details related to the rewards redeemed in the physical manner can include, but are not limited to, an order identifier, a date of order placed, a shipping address for the corresponding order, a name and quantity of the rewards in the order, and so forth. Embodiments of the present disclosure are intended to include or otherwise cover any additional details related to the rewards redeemed in the physical manner that can be provided by the reward redemption module 312, including known, related art, and/or later developed technologies.

According to embodiments of the present disclosure, the reward redemption module 312 can further be configured to provide information related to the selected game play such as, but not limited to, the name of the game played, a time of the game played, a date of the game played, an expenditure of the coins for the game played, an earning of the coins from the game played, and so forth. Embodiments of the present disclosure are intended to include or otherwise cover any information related to the selected game play that can be provided by the reward redemption module 312, including known, related art, and/or later developed technologies.

In yet another embodiment of the present disclosure, the reward redemption module 312 can further be configured to enable the user to redeem coins that can be credited into the wallet of the user for upgrading and/or modifying the avatar and/or the facial features of the avatar of the user.

According to embodiments of the present disclosure, the notification module 314 can be configured to be activated upon receipt of the first notification signal form the game selection module 306. When activated from the first notification signal, the notification module 314 can be configured to display the first notification on the user device 102, according to embodiments of the present disclosure. According to embodiments of the present disclosure, the first notification can inform the user about the demonstration game being played of the selected game. The first notification can further inform the user of potential reward wins and/or losses after successful completion of the selected demonstration game, according to embodiments of the present disclosure.

In another embodiment of the present disclosure, the notification module 314 can be configured to be activated upon receipt of the second notification signal from the payment module 308. When activated from the second notification signal, the notification module 314 can be configured to display a second notification on the user device 102, according to embodiments of the present disclosure. According to embodiments of the present disclosure, the second notification can inform the user about insufficient coins in the wallet of the user, where the amount of the coins is insufficient to satisfy the amount of coins, required to play the selected game.

Further, the notification module 314 can be configured to be activated upon receipt of the third notification signal from the game play module 310. When activated from the third notification signal, the notification module 314 can be configured to display a third notification on the user device 102, according to embodiments of the present disclosure. According to embodiments of the present disclosure, the third notification can inform the user about the queued and/or waiting status of the game machine 106 corresponding to the game selected to be played by the user.

In yet another embodiment of the present disclosure, the notification module 314 can be configured to be activated upon receipt of the fourth notification signal form the game play module 310. When activated from the fourth notification signal, the notification module 314 can be configured to display a fourth notification on the user device 102, according to embodiments of the present disclosure. According to embodiments of the present disclosure, the fourth notification can inform the user about the available status of the game machine 106 corresponding to the game selected to be played by the user.

In a further embodiment of the present disclosure, the notification module 314 can be configured to be activated upon receipt of the fifth notification signal from the reward redemption module 312. When activated from the fifth notification signal, the notification module 314 can be configured to display a fifth notification on the user device 102, according to embodiments of the present disclosure. According to embodiments of the present disclosure, the fifth notification can inform the user about the expiration of the coin expiry timer.

In a further embodiment of the present disclosure, the notification module 314 can be configured to be activated upon receipt of the sixth notification signal from the reward redemption module 312. When activated from the sixth notification signal, the notification module 314 can be configured to display a sixth notification on the user device 102, according to embodiments of the present disclosure. According to embodiments of the present disclosure, the sixth notification can inform the user about the elapsing of the reward expiry timer.

In a further embodiment of the present disclosure, the notification module 314 can further be configured to generate and display a seventh notification on the user device 102 to enable the user to allow and/or reject sharing of updates on social media accounts.

According to embodiments of the present disclosure, the first notification, the second notification, the third notification, the fourth notification, the fifth notification, the sixth notification, and the seventh notification received on the user device 102 can be in a pre-defined form. The pre-defined format of the notification can be, but is not limited to a pop-up notification, a flash notification, a ringer notification, a silent notification, a push notification, a hidden notification, an electronic mail notification, a Short Message Service (SMS) notification, an always on-screen notification, and so forth. Embodiments of the present disclosure are intended to include or otherwise cover any form of notification, including known, related art, and/or later developed technologies.

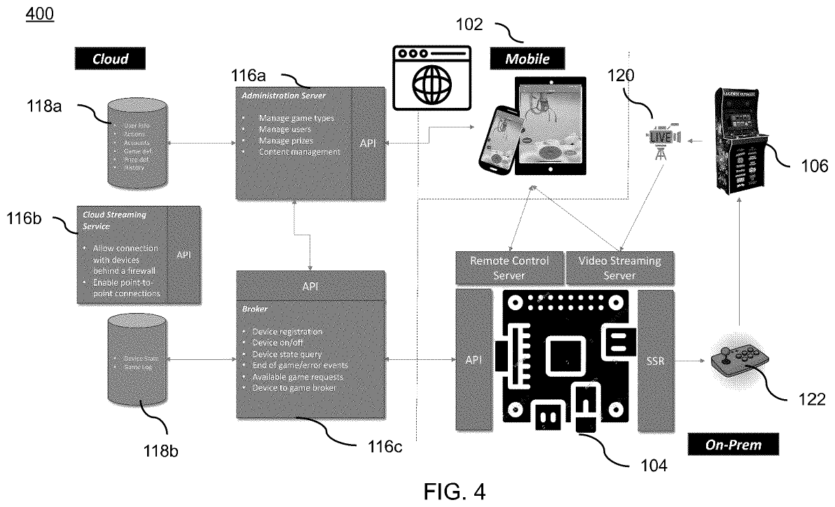

FIG. 4 illustrates an architecture schema 400 of the system 100, according to embodiments of the present disclosure. According to embodiments of the present disclosure, the system 100 can provide for user device 102 to be communicatively connected to the game machine 106 through the application server 104. The application server 104 can further include the gaming platform 116 and the database 118, according to embodiments of the present disclosure. According to embodiments of the present disclosure, the gaming platform 116 can include several Application Programming Interfaces (APIs) that can facilitate data and information linkage between the gaming platform 116 and the database 118, and the gaming platform 116 and other components of the system 100. According to some embodiments of the present disclosure, the application server 104 can be located at the same location as the game machine 106. According to other embodiments of the present disclosure, the application server 104 can be located at a remote location from the game machine 106.

The Application Programming Interfaces (APIs) can include, but are not limited to, an Application Programming Interface (API) related to administrator actions 116a, an Application Programming Interface (API) related to game machine 106 actions 116b, Application Programming Interface (API) related to service provider actions 116c, and so forth. Embodiments of the present disclosure are intended to include or otherwise cover any Application Programming Interfaces (APIs) that can further be facilitated to generate data and information linkage between any components of the system 100, related art, and/or later developed technologies.

According to embodiments of the present disclosure, the administrator actions controlled by the Application Programming Interface (API) related to administrator actions 116a can include, but are not limited to, a management of the game types, a management of the users, a management of the rewards, a management of the contents, and so forth. Embodiments of the present disclosure are intended to include or otherwise cover any administrator actions that can be controlled by the Application Programming Interface (API) related to administrator actions 116a, including known, related art, and/or later developed technologies.

According to embodiments of the present disclosure, the database 118a can be connected to the Application Programming Interface (API) related to administrator actions 116a. An administrator can be eligible to read, write, and modify data stored in the database 118a, according to embodiments of the present disclosure. According to embodiments of the present disclosure, details stored in the database 118a can include, but are not limited to, details related to the user, a set of actions that can be performed by the user, account details of the user, a game directory, a rewards directory, a history and records of game played by a selected user, and so forth. Embodiments of the present disclosure are intended to include or otherwise cover any details that can be stored in the database 118a, including known, related art, and/or later developed technologies.

According to embodiments of the present disclosure, the actions controlled by the Application Programming Interface (API) related to game machine 106 actions 116b can include, but are not limited to, generation and provision of linkage between the user device 102 and the game machine 106 behind a firewall, development of point-to-point connections among the game machine 106, and so forth. Embodiments of the present disclosure are intended to include or otherwise cover any actions that can be controlled by the Application Programming Interface (API) related to game machine 106 actions 116b, including known, related art, and/or later developed technologies.

According to embodiments of the present disclosure, the service provider actions controlled by the Application Programming Interface (API) related to service provider actions 116c can include, but are not limited to, a registration of the game machine 106, querying and updating the status of the game machine 106, flagging and resolving errors triggered in the game machine 106, availing game requests for the corresponding game machine, and so forth. Embodiments of the present disclosure are intended to include or otherwise cover any service provider actions that can be controlled by the Application Programming Interface (API) related to service provider actions 116c, including known, related art, and/or later developed technologies.

According to embodiments of the present disclosure, the database 118b can be connected to the Application Programming Interface (API) related to service provider actions 116c. The service provider can be eligible to read, write, and modify data stored in the database 118b, according to embodiments of the present disclosure. According to embodiments of the present disclosure, details stored in the database 118b can include, but are not limited to, the status of the game machine 106, a log of arcade games that can played on the corresponding game machine 106, and so forth. Embodiments of the present disclosure are intended to include or otherwise cover any details that can be stored in the database 118b, including known, related art, and/or later developed technologies.

In another embodiment of the present disclosure, the media streaming unit 120 and/or the game controlling unit 122 can be arranged with/inside of the game machine 106.

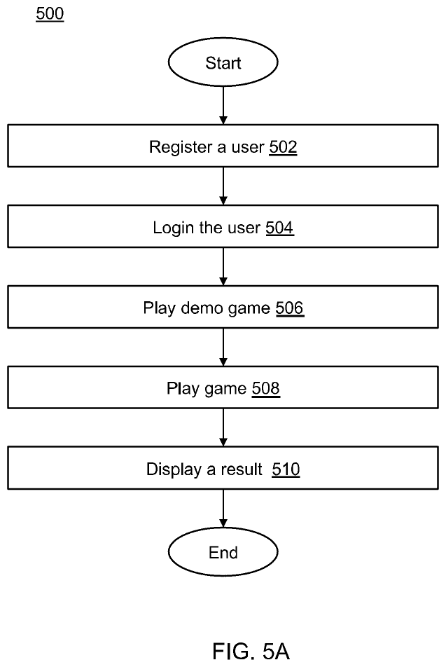

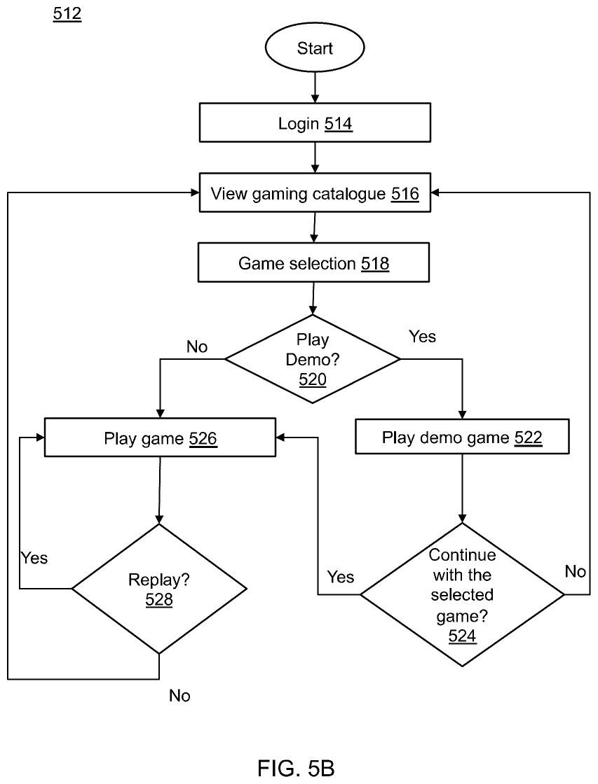

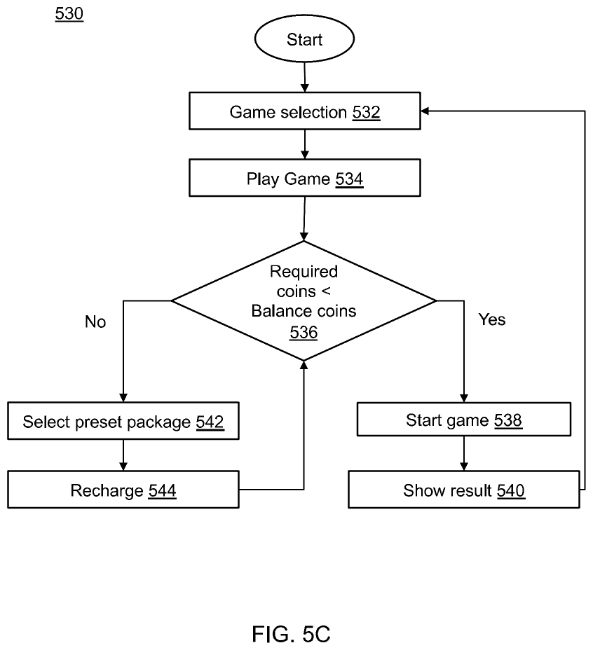

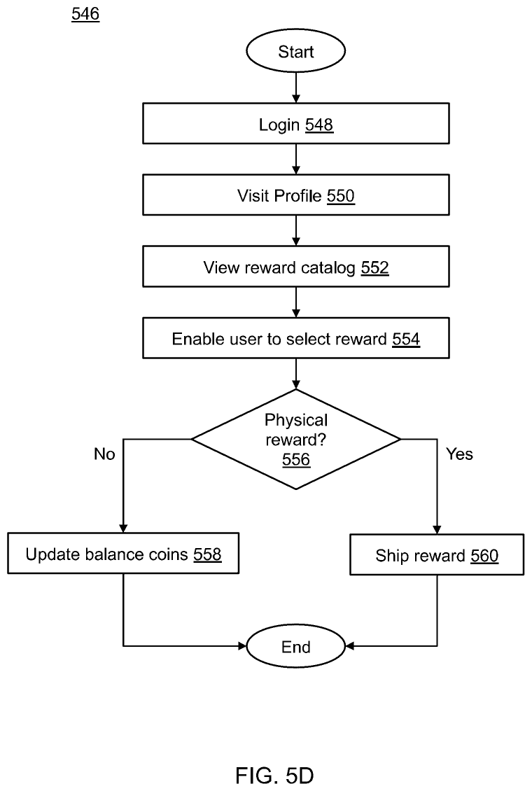

FIG. 5A illustrates a process flow diagram 500 of the system 100 for playing arcade games, according to embodiments of the present disclosure. At step 502, the system 100 enables the user to register on the gaming application 110. The registration of the user can be done by providing the user details, as discussed above.

At step 504, the system 100 enables the user to login into the gaming application 110 by using the login credentials such as, the username and the password of the user or by using the biometric credentials of the user.

At step 506, the system 100 enables the user to select the arcade game from a catalog and play the demonstration game of the selected game before playing the game in a real-time environment from a remote location.

At step 508, the system 100 enables the user to play the selected game in the real-time environment.

At step 510, the system 100 displays the result of the selected game played by the user.

FIG. 5B illustrates a method 512 for game play on the system 100 for playing arcade games, according to embodiments of the present disclosure. At step 514, the system 100 can enable the user to login into the gaming application 110 by using the log in credentials such as, a username and a password of the user or by using the biometric credentials of the user.

At step 516, the system 100 enables the user to view the gaming catalog. According to embodiments of the present disclosure, the gaming catalog can include details of arcade games such as, but not limited to, a category of arcade games, a name of the arcade game, a representational image of the arcade game, a current status of the arcade games, a number of coins required to play the selected arcade game, and so forth. Embodiments of the present disclosure are intended to include or otherwise cover any details of arcade games that can show in the gaming catalog, including known, related art, and/or later developed technologies.

At step 518, the system 100 enables the user to select the arcade game from the gaming catalog to be played on the user device 102. As discussed above, the arcade games are installed at a remote location such as, a shopping mall, the arcade game parlor, etc.

At step 520, the system 100 further determines whether the user desires to play a demonstration game or not. If the system 100 determines that the user desires to play the demonstration game of the selected game, then the method 512 proceeds to a step 522. Otherwise, the method 512 continues to step 526.

At the step 522, the system 100 enables the user to play the demonstration of the selected game.

At step 524, the system 100 determines whether the user desires to continue playing with the selected game or not. If the system 100 determines that the user elects to continue with the selected game, then the method 512 proceeds to the step 526. Otherwise, the method 512 returns to step 516.

At step 526, the system 100 enables the user to play the selected game.

At step 528, the system 100 determines whether the user desires to play the selected game again or not. If the system 100 determines that the user desires to replay the selected game, then the method 512 returns to step 526. Otherwise, the method 512 returns to step 516 and the user can select a new game from the gaming catalog.

FIG. 5C illustrates a method 530 to manage balance coins on the system 100 for playing arcade games, according to embodiments of the present disclosure.

At step 532, the system 100 enables the user to select the arcade game to be played from the gaming catalog.

At step 534, the system 100 enables the user to play the selected game.

At step 536, the system 100 determines whether the coins required to play the selected game are less than the coins in the wallet of the user or not. If the system 100 determines that the coins required to play the selected game are less than the coins in the wallet of the user, then the method 530 proceeds to step 538. Otherwise, the method 530 proceeds to step 542.

At step 538, the system 100 enables the user to start playing the selected game.

Further, at step 540, the system 100 displays the result of the selected game played once the played game is over. After the system 100 displays the result, the method 530 returns to step 532 where the user can select another arcade game to be played from the gaming catalog.

At step 542, the system 100 enable the user to select from one or more preset packages to recharge the coins in the user's wallet in order to play the arcade games.

At step 544, the system 100 enable the user to recharge the coins in the wallet using the payment method, as discussed above. Upon successful recharge, the method 530 returns to step 536.

FIG. 5D illustrates a method 546 for reward redemption on the system 100, according to embodiments of the present disclosure.

At step 548, the system 100 enables the user to login, as discussed above.

At step 550, the system 100 enables the user to visit a profile section in the user interface 112 of the gaming application.

At step 552, the system 100 enables the user to view a reward catalog.

At step 554, the system 100 enables the user to select the reward to be redeemed from the reward catalog.

At step 556, the system 100 determines whether the user selects the physical reward that can be shipped in the physical manner or the number of coins equivalent to the selected rewards that can be credited to the wallet of the user. If the user selects the reward that can be shipped in the physical manner, then the method 546 proceeds to step 560. Otherwise, if the user selects the number of coins equivalent to the selected rewards that can be credited in the wallet of the user, then the method 546 proceeds to step 558.

At step 558, the system 100 credits the number of coins equivalent to the selected rewards in the wallet.

At the step 560, the system 100 enables the user to confirm the address and the postal code and ship the selected rewards in the physical manner.

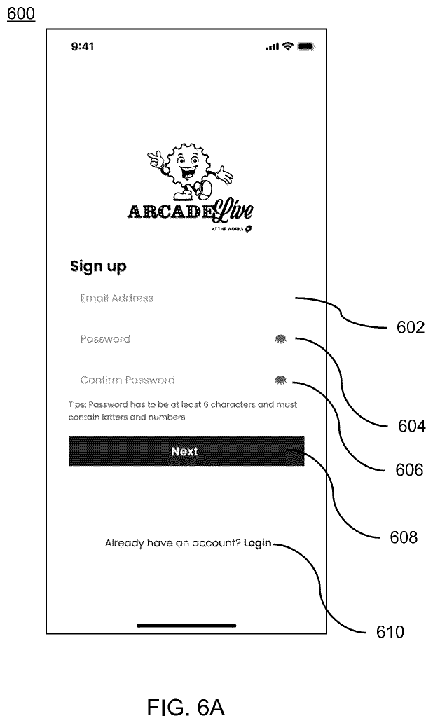

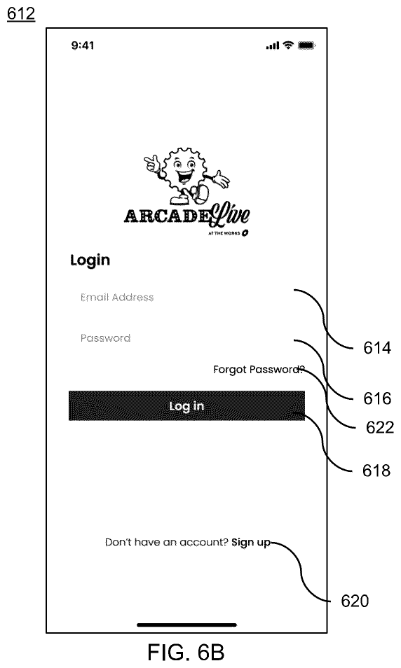

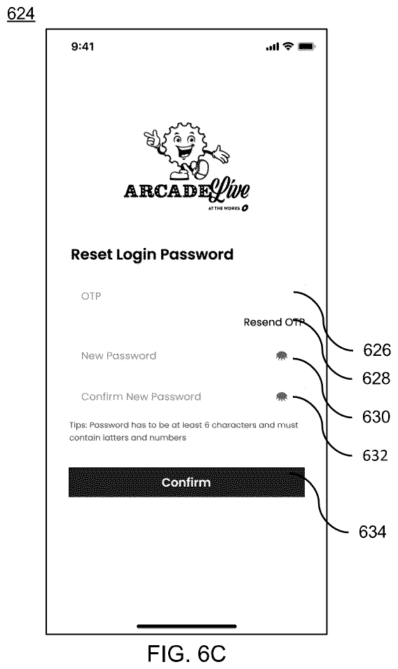

FIG. 6A illustrates a registration page 600 of the gaming application 110, according to embodiments of the present disclosure. According to embodiments of the present disclosure, the registration page 600 of the gaming application 110 can be used by the new user for onboarding on the system 100. The user can sign in to the gaming application 110 by providing an electronic mail address 602. The user can then enter a password 604, according to embodiments of the present disclosure. Further, the user can confirm the password by refilling the password 606. Further, the user can click on a next button 608. If the user is a registered user, then the user can click on a login button 610. Upon clicking on the login button 610, the gaming application 110 can redirect the user to a login page 612, as shown in FIG. 6B.

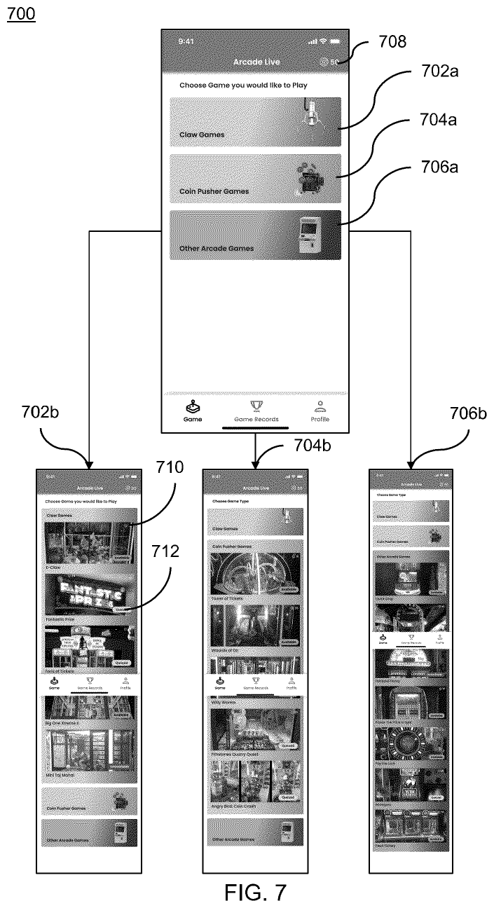

FIG. 6B illustrates the login page 612 of the gaming application 110, according to embodiments of the present disclosure. According to embodiments of the present disclosure, the user can provide the registered electronic mail address 614. The user can further provide a password 616 associated with the registered electronic mail address 614. Further, the user can click on a login button 618. According to embodiments of the present disclosure, a successful login can lead the user to a game catalog page 700 of the gaming application 110, as shown in FIG. 7. In another embodiment of the present disclosure, the new user can click on a sign-up button 620 for onboarding on the system 100. Clicking on the sign-up button 620 can redirect the new user to the registration page 600 of the gaming application 110, as shown in the FIG. 6A.

In yet another embodiment of the present disclosure, if the registered user is unable to successfully log in to the gaming application 110, then the user can click on a forgot password button 622. Clicking on the forgot password button 622 can redirect the user to a reset credentials page 624, as shown in the FIG. 6C.

FIG. 6C illustrates the reset credentials page 624 of the gaming application 110, according to embodiments of the present disclosure. The user can provide a One Time Password (OTP) 626 received on the registered electronic mail address. The One Time Password (OTP) 626 received on the registered electronic mail address can be valid for a certain amount of time, and upon expiry of the OTP, the user can click on a Resend One Time Password (OTP) button 628 to regenerate a new One Time Password (OTP). According to embodiments of the present disclosure, the user can provide a new password 630 and confirm the same new password 632, respectively. The user can click on a confirm button 634, after providing the new password 630 and the confirmed new password 632. Clicking on the confirm button 634, the gaming application 110 can redirect the user to the login page 612, as shown in the FIG. 6B.

FIG. 7 illustrates a game catalog page 700 of the gaming application 110, according to embodiments of the present disclosure. The user can be provided with game categories such as claw games 702a, coin pusher games 704a, and other arcade games 706a, to select a game to be played. Clicking on the claw games 702a, a claw games category 702b can expand and display all available games belonging to the claw games category 702b, according to embodiments of the present disclosure. In another embodiment of the present disclosure, clicking on the coin pusher games 704a, a coin pusher games category 704b can expand and display all available games belonging to the coin pusher games category 704b. Further, clicking on the other arcade games 706a, other arcade games category 706b can expand and display all other available games belonging to the arcade games category 706b, in yet another embodiment of the present disclosure. According to embodiments of the present disclosure, the game catalog page 700 of the gaming application 110 can further represent the balance coins 708 in the wallet of the user. Upon expansion of the game category, every game can represent a number of coins 710 required for playing the selected game, along with the status 712 of the selected game, according to embodiments of the present disclosure. According to embodiments of the present disclosure, the status 712 of the selected game can depend upon the status of the corresponding game machine 106. According to embodiments of the present disclosure, the status 712 of the selected game can be reflected as “unavailable” when the corresponding game machine 106 on which the selected game can be played can be in the unavailable status. In another embodiment of the present disclosure, the status 712 of the selected game can be reflected as “available” when the corresponding game machine 106 on which the selected game can be played can be in the available status. In yet another embodiment of the present disclosure, the status 712 of the selected game can be reflected as “waiting” when the corresponding game machine 106 on which the selected game can be played is in the waiting status.

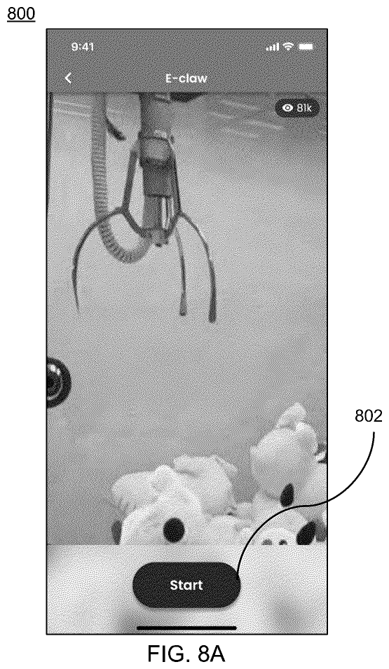

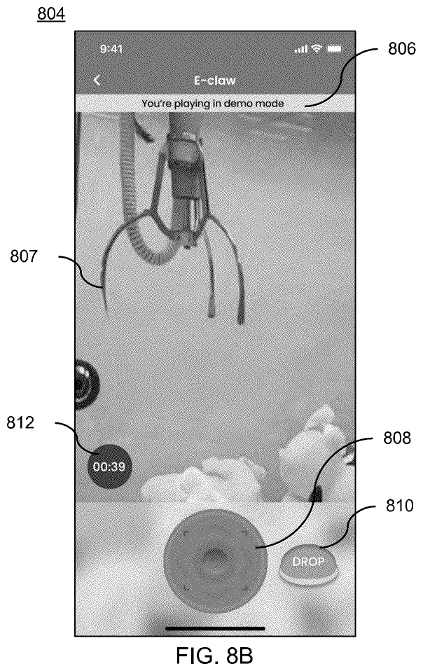

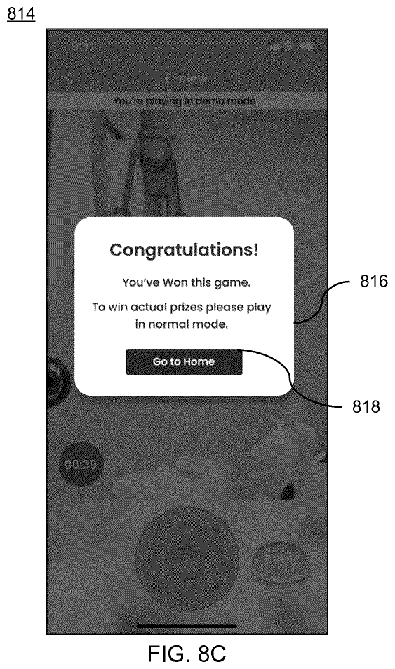

According to embodiments of the present disclosure, the user can select any arcade game of choice to be played from the claw games category 702b, the coin pusher games category 704b, or the other arcade games category 706b. In one example, the user can select the electronic claw game and, upon selecting the electronic claw game, the user can be redirected to a demonstration game start page 800 of the electronic claw game, as shown in the FIG. 8A.

FIG. 8A illustrates the demonstration game start page 800 of the gaming application 110, according to embodiments of the present disclosure. The demonstration game represented in the demonstration game start page 800 can be an electronic claw game. Furthermore, the demonstration game represented in the demonstration game start page 800 can be a virtual (e.g., simulated) representation of the game, or can be a physical (e.g., live streamed) representation of the game. According to embodiments of the present disclosure, the user can click on a start button 802 to play the demonstration game for the electronic claw game. Upon clicking the start button 802 the user can be redirected to a demonstration game play page 804, as shown in the FIG. 8B for the electronic claw game.

FIG. 8B illustrates the demonstration game play page 804 of the gaming application 110, according to embodiments of the present disclosure. The demonstration game play page 804 can represent a demonstration notification 806 that the user is playing in a demo mode. The user can control an electronic claw 807 in the electronic claw game using a navigational joystick 808, according to embodiments of the present disclosure. In a further embodiment of the present disclosure, the user can click a drop button 810 to drop the reward in the reward drop area, which can further be collected in a bin. The demonstration game play page 804 can show a timer 812 to the user, according to embodiments of the present disclosure. If the user completes a goal of the electronic claw game within the predefined time, then the user can be redirected to a demonstration game won page 814, as shown in the FIG. 8C.

FIG. 8C illustrates the demonstration game won page 814 of the gaming application 110, according to embodiments of the present disclosure. When the user completes the goal of the electronic claw game within the predefined time, for example, the user is able to drop the electronic claw 807 and the electronic claw 807 grabs a toy in the game machine 106, then the demonstration game won page 814 can display a demonstration game won banner 816 that shows that the user has won this game. However, in order to win actual prizes, the user can be required to play in a normal mode and not in the demonstration mode. The user can further click on a go to home button 818 to visit the game catalog page 700 of the gaming application 110, as shown in the FIG. 7.

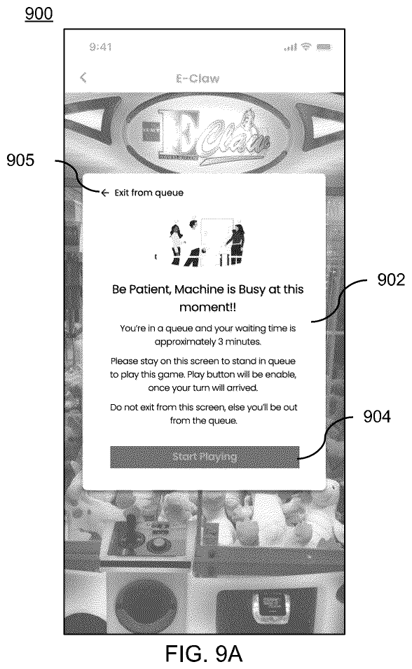

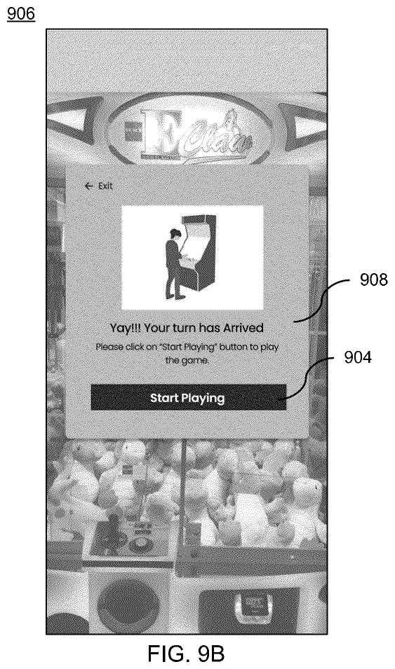

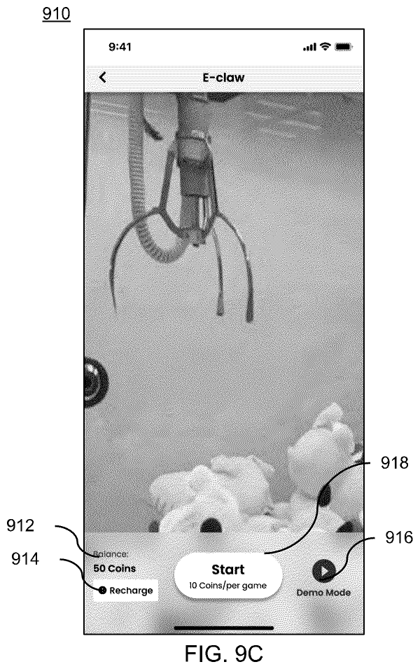

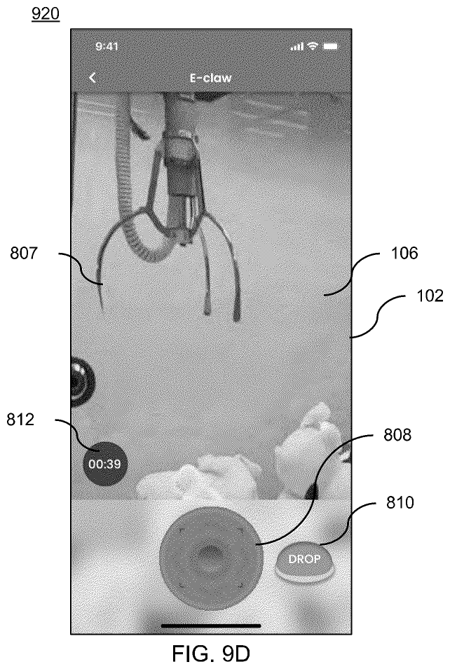

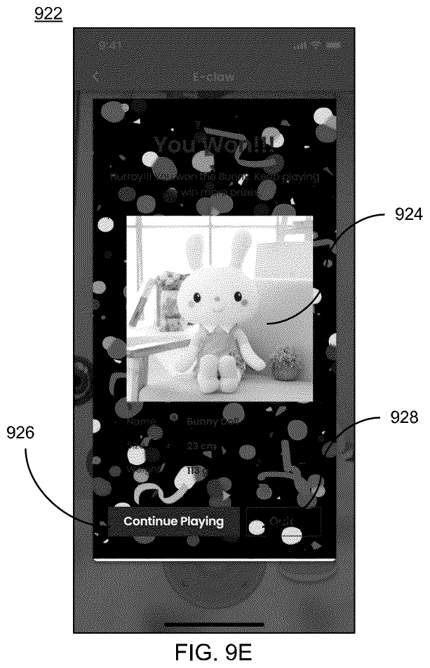

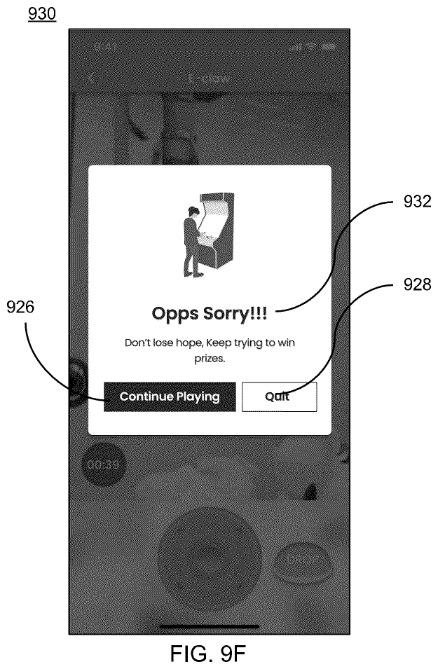

According to one example, if the user desires to play the electronic claw game, then the user can select the electronic claw game from the game catalog page 700 of the gaming application 110. The claw games can be listed by prize and a picture of the prize can be presented in an image window above a description of the prize. However, if the game machine 106 for the selected game (e.g., electronic claw game) is currently in use by another user, then the user can be redirected to a waiting que page 900, or presented with a machine busy state message and the user control is returned to the application end user, as shown in FIG. 9A.

FIG. 9A illustrates the waiting queue page 900 of the gaming application 110, according to embodiments of the present disclosure. The waiting queue page 900 can display a waiting queue banner 902 to notify the user that the game machine 106 is being used by another user. Further, the notification can also notify the user of the approximate waiting time for the game machine 106 (e.g., 3 minutes). As the status of the game machine 106 is “queued,” a start playing button 904 can be disabled, according to embodiments of the present disclosure. According to embodiments of the present disclosure, when the status of the corresponding game machine 106 is change from “queued” to “available,” the start playing button 904 can be enabled, and the user can be redirected to a turn arrival page 906, as shown in FIG. 9B. If the user does not desire to wait in the queue of the game machine 106, the user can click on an “exit the queue” button 905 and can be returned to the game catalog page 700 of the gaming application 110 to select another game.

FIG. 9B illustrates the turn arrival page 906 of the gaming application 110, according to embodiments of the present disclosure. The turn arrival page 906 can display a turn arrival banner 908 to notify the user that the user's turn has arrived and the user can then play the game. As the status of the game machine 106 is changed to “available,” the start playing button 904 can be enabled. According to embodiments of the present disclosure, upon clicking on the start playing button 904, the user can be redirected to a game start page 910, as shown in FIG. 9C.

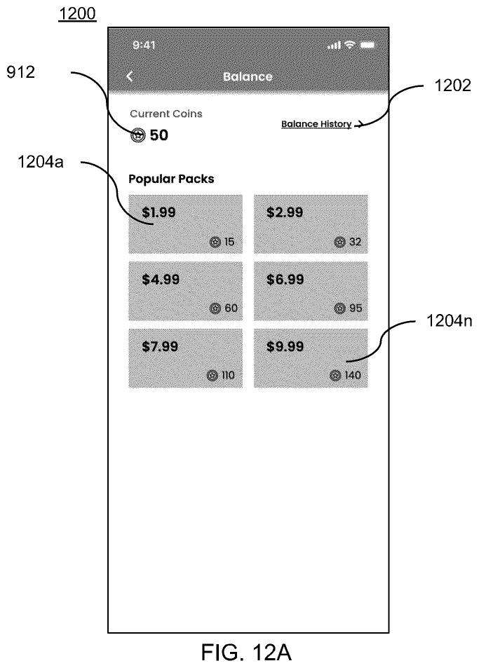

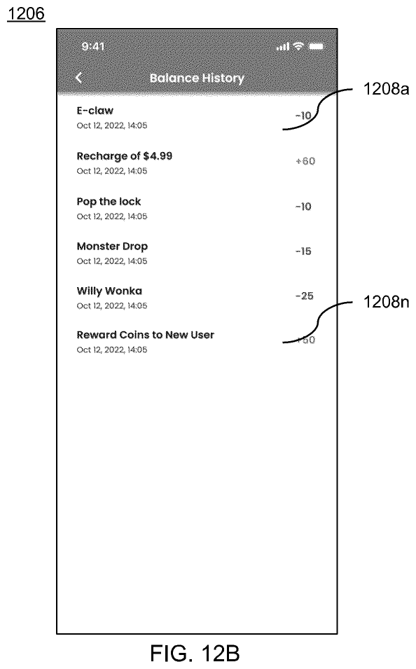

FIG. 9C illustrates the game start page 910 of the gaming application 110, according to embodiments of the present disclosure. The game start page 910 can display the balance coins 912 in the wallet of the user. The game start page 910 can further provide a recharge button 914. Upon clicking the recharge button 914, the user can be redirected to a coin balance page 1200, as shown in FIG. 12A, of the gaming application 110, according to embodiments of the present disclosure. In another embodiment of the present disclosure, the game start page 910 can provide a demo button 916, upon clicking the demo button 916, the user can be redirected to the demonstration game start page 800 of the gaming application 110. The game start page 910 can further provide a game start button 918, upon clicking the game start button 918, the user can be redirected to a game play page 920 of the gaming application 110, as shown in FIG. 9D.

FIG. 9D illustrates the game play page 920 of the gaming application 110, according to embodiments of the present disclosure. The game play page 920 can enable the user to play the electronic claw game. The user can control the electronic claw 807 in the electronic claw game using the navigational joystick 808. In a further embodiment of the present disclosure, the user can click the drop button 810 to drop the reward in the reward drop area when the electronic claw 807 can be able to grab a reward from the game machine 106, which can further be collected in the bin (not shown). While playing the game, the user can see the surroundings of the game machine 106 telecasted and/or live-streamed by the media streaming unit 120 by rotating and/or by swiping on the display unit of the user device 102. In another embodiment of the present disclosure, the user can utilize the input means of the user device 102 to rotate the view of the game machine 106 provided by the media streaming unit 120.

The game play page 920 can show a timer 812 to the user, which displays the remaining time to play the game, according to embodiments of the present disclosure. According to embodiments of the present disclosure, if the user completes a goal of the electronic claw game within the predefined time and the electronic claw 807 was able to grab a reward from the game machine 106, then the user can be redirected to a game won page 922, as shown in FIG. 9E. Otherwise, the user can be redirected to game lost page 930, as shown in FIG. 9F.

FIG. 9E illustrates the game won page 922 of the gaming application 110, according to embodiments of the present disclosure. The game won page 922 can display a game won banner 924 to the user to notify the user about the reward won by the user. Further, the game won page 922 can provide a continue playing button 926 to enable the user to continue playing the same game by redirecting it to the game catalog page 700 of the gaming application 110, according to embodiments of the present disclosure. In another embodiment of the present disclosure, the game won page 922 can provide a quit button 928 that can enable the user to make an exit from the game in the gaming application 110.

FIG. 9F illustrates the game lost page 930 of the gaming application 110, according to embodiments of the present disclosure. According to embodiments of the present disclosure, the game lost page 930 can display a game lost banner 932 to the user. Further, the game lost page 930 can provide the continue playing button 926, and by clicking on the continue playing button 926, the user can be redirected to the game catalog page 700 of the gaming application 110, according to embodiments of the present disclosure. In another embodiment of the present disclosure, the game lost page 930 can provide the quit button 928 and clicking on the quit button 928 can enable the user to make an exit from the game in the gaming application 110.

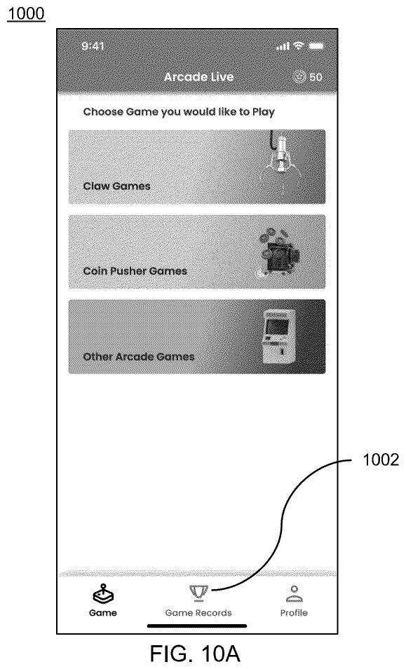

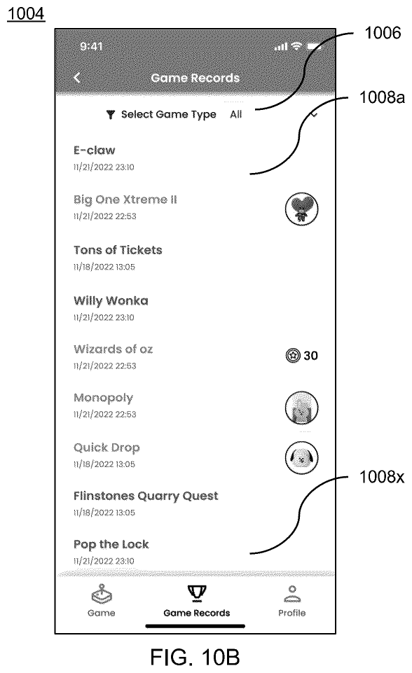

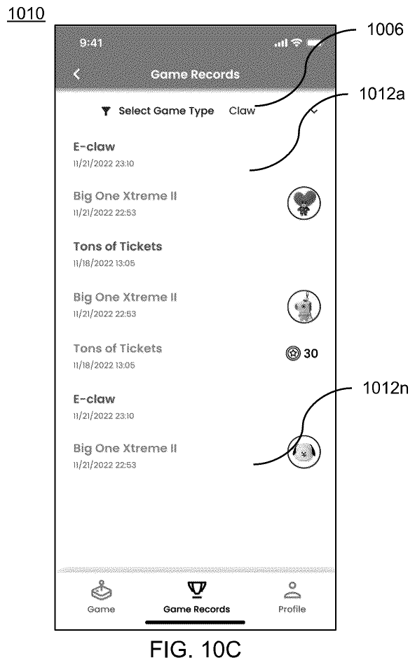

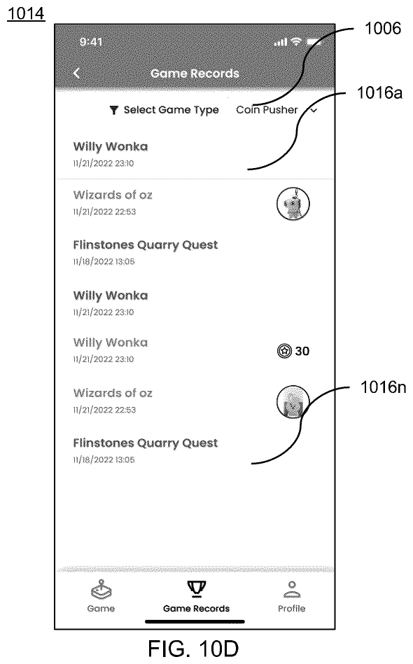

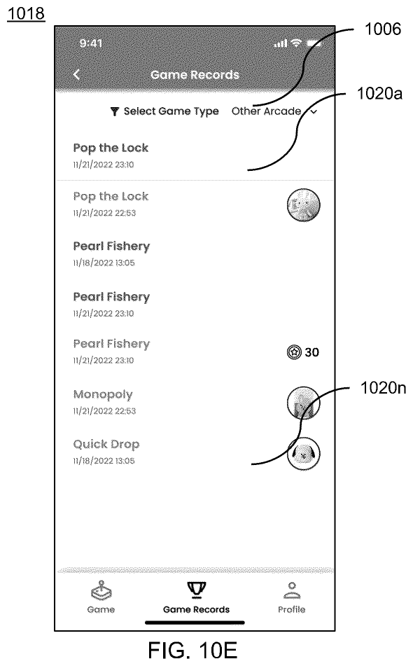

FIG. 10A illustrates a game home page 1000 of the gaming application 110, according to embodiments of the present disclosure. According to embodiments of the present disclosure, the game home page 1000 can provide a game records button 1002. Clicking on the game records button 1002, the user can be redirected to a first game record home page 1004, as shown in FIG. 10B.

FIG. 10B illustrates the first game record home page 1004 of all games that were previously played by the user in the gaming application 110, according to embodiments of the present disclosure. The first game record home page 1004 can enable the user to filter the displayed game records by using a filter 1006. The first game record home page 1004 can display all game records 1008a-1008x without any particular sorting or suppression filter applied, according to embodiments of the present disclosure. According to embodiments of the present disclosure, the displayed game records 1008a-1008x can further provide information related to each of the games such as, but not limited to, the name of the game, the time of game play, the date of game play, the result of game play, the rewards 124 of game play (e.g., coins, toys, etc.) and so forth. Embodiments of the present disclosure are intended to include or otherwise cover any information related to the game that can be displayed in the game records 1008a-1008x, including known, related art, and/or later developed technologies.

FIG. 10C illustrates a second game record home page 1010 where a filter 1006 is applied to the gaming application 110, according to embodiments of the present disclosure. According to embodiments of the present disclosure, the second game record home page 1010 can enable the user to apply a filter and display only the claw games 702a records using the filter 1006. The second game record home page 1010 can show all game records 1012a-1012n belonging to the claw games 702a with a claw filter applied, according to embodiments of the present disclosure. According to embodiments of the present disclosure, the displayed game records 1012a-1012n can further provide information related to the claw games 702a such as, but not limited to, the name of the game, the time of game play, the date of game play, the result of game play, the rewards 124 of game play, and so forth. Embodiments of the present disclosure are intended to include or otherwise cover any information related to the claw games 702a that can be displayed in the game records 1012a-1012n with the claw filter applied, including known, related art, and/or later developed technologies.

FIG. 10D illustrates a third game record home page 1014 with another filter applied to the gaming application 110, according to embodiments of the present disclosure. The third game record home page 1014 can enable the user to apply a filter and display only the coin pusher games 704a records using the filter 1006. The third game record home page 1014 can display all game records 1016a-1016n belonging to the coin pusher games 704a with a coin pusher filter applied, according to embodiments of the present disclosure. According to embodiments of the present disclosure, the displayed game records 1016a-1016n can further provide information related to the coin pusher games 704a such as, but not limited to, the name of the game, the time of game play, the date of game play, the result of game play, the rewards 124 of game play, and so forth. Embodiments of the present disclosure are intended to include or otherwise cover any information related to the coin pusher games 704a that can be displayed in the game records 1016a-1016n with the coin pusher filter applied, including known, related art, and/or later developed technologies.

FIG. 10E illustrates a fourth game record home page 1018 with yet another filter applied to the gaming application 110, according to embodiments of the present disclosure. The fourth game record home page 1018 can enable the user to apply a filter and display only the other arcade games 706a records using the filter 1006. The fourth game record home page 1018 can display all game records 1020a-1020n belonging to the other arcade games 706a with other arcade pusher filter applied, according to embodiments of the present disclosure. According to embodiments of the present disclosure, the displayed game records 1020a-1020n can further provide information related to the other arcade games 706a such as, but not limited to, the name of the game, the time of game play, the date of game play, the result of game play, the rewards 124 of game play, and so forth. Embodiments of the present disclosure are intended to include or otherwise cover any information related to the other arcade games 706a that can be displayed in the game records 1020a-1020n with the other arcade games 706a filter applied, including known, related art, and/or later developed technologies.

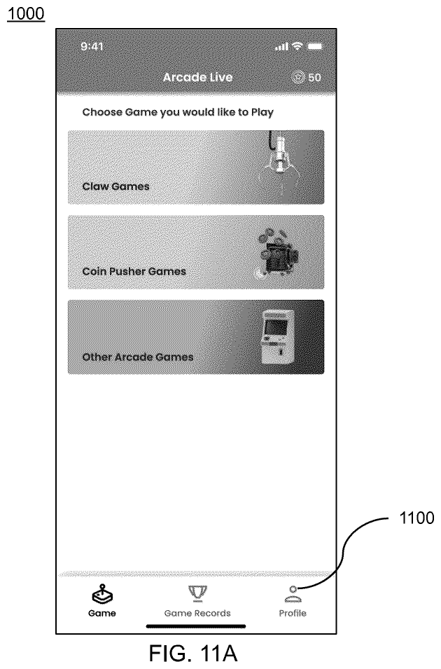

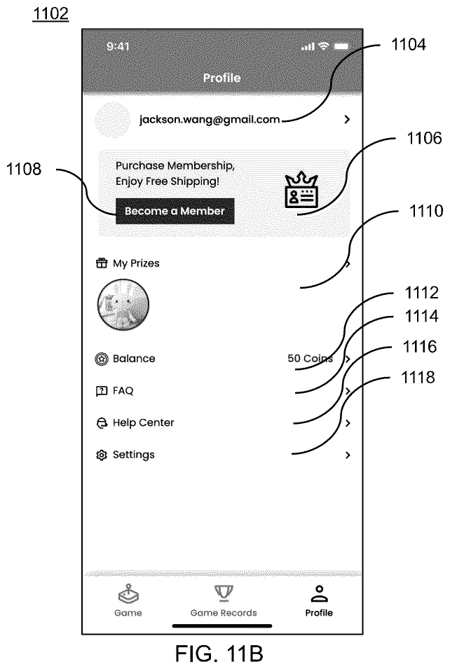

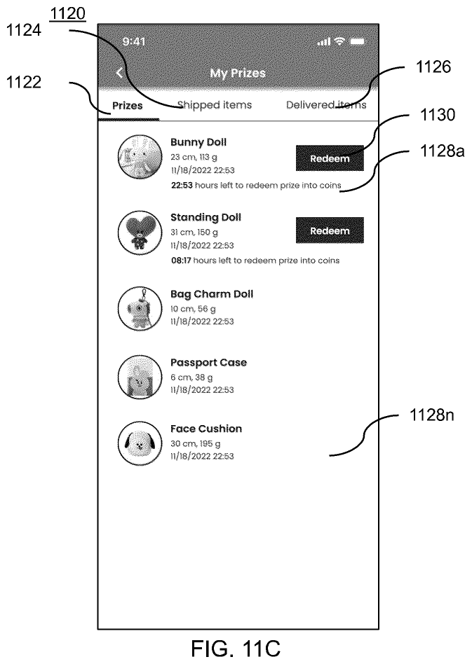

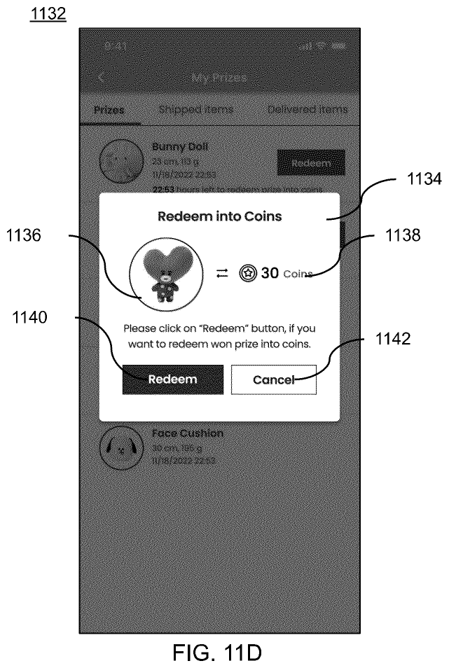

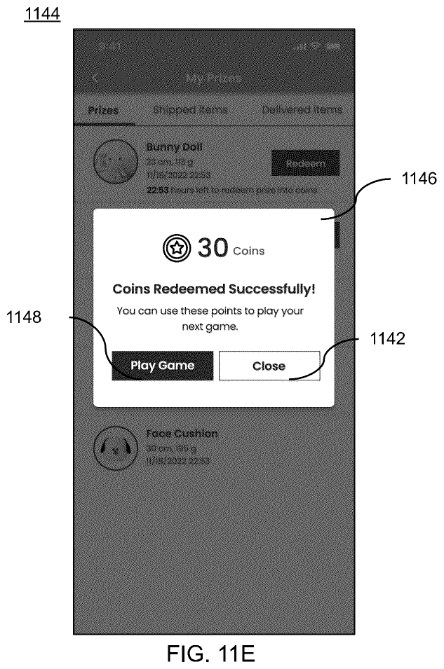

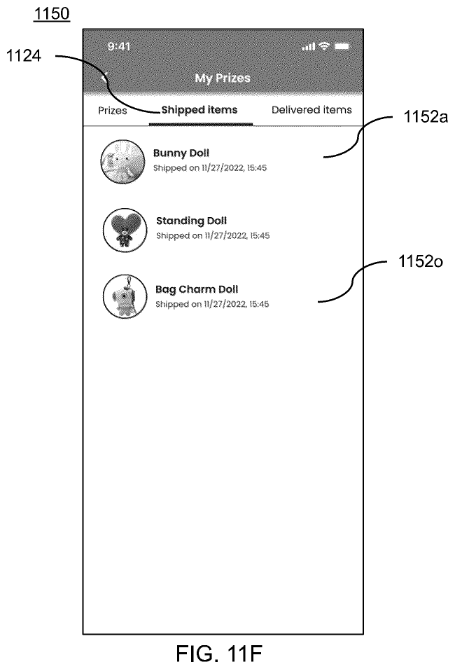

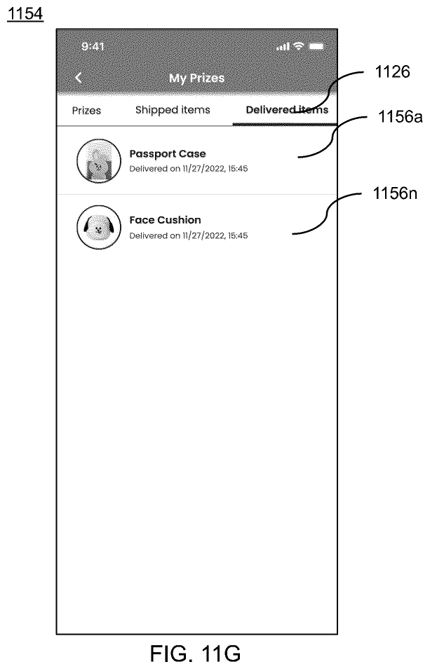

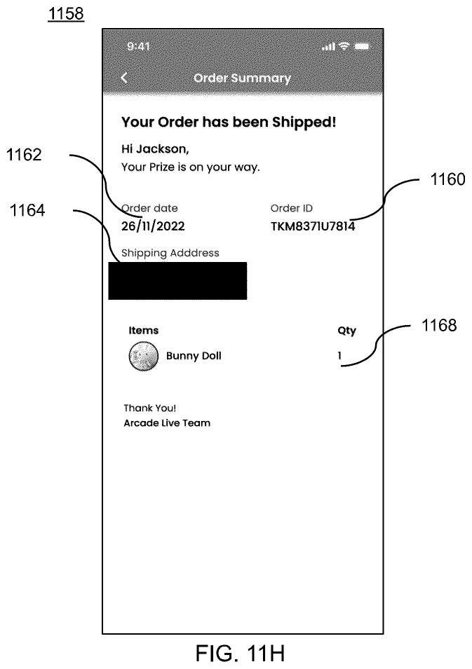

FIG. 11A illustrates the game home page of the gaming application 110, according to embodiments of the present disclosure. The game home page 1000 can provide a profile button 1100. Clicking on the profile button 1100, the user can be redirected to a profile home page 1102, as shown in FIG. 11B.

FIG. 11B illustrates the profile home page 1102 of the gaming application 110, according to embodiments of the present disclosure. The profile home page 1102 can display the registered electronic mail 1104 of the user. The profile home page 1102 can further display a membership banner 1106. According to embodiments of the present disclosure, the membership banner 1106 can further provide a become a member button 1108 and clicking on the become a member button 1108 the user can be enrolled in a membership program by paying a certain amount as a membership fee. The profile home page 1102 can further provide a “my prizes” section 1110, clicking on the “my prizes” section 1110, the user can be redirected to a rewards won page 1120 of the gaming application 110, according to embodiments of the present disclosure, as shown in FIG. 11C. According to embodiments of the present disclosure, the profile home page 1102 can further provide a balance section 1112, clicking on the balance section 1112, the user can be redirected to the coin balance page 1200, as shown in FIG. 12A.

According to embodiments of the present disclosure, the profile home page 1102 can further provide a Frequently Asked Questions (FAQ) section 1114, clicking on the Frequently Asked Questions (FAQ) section 1114, the user can be redirected to a Frequently Asked Questions page (not shown). According to embodiments of the present disclosure, the profile home page 1102 can further provide a help center section 1116, clicking on the help center section 1116, the user can be redirected to a help center section page (not shown). According to embodiments of the present disclosure, the profile home page 1102 can further provide a settings section 1118, clicking on the settings section 1118, the user can be redirected to a settings page (not shown).

FIG. 11C illustrates the rewards won page 1120 of the gaming application 110, according to embodiments of the present disclosure. According to embodiments of the present disclosure, the rewards won page 1120 can show a prizes tab 1122, a shipped items tab 1124, and a delivered items tab 1126. Upon clicking on the shipped items tab 1124, the user can be redirected to a shipped reward page 1150 of the gaming application 110, as shown in FIG. 11F. Further, by clicking on the delivered items tab 1126, the user can be redirected to a delivered reward page 1154 of the gaming application 110, as shown in FIG. 11G.

According to embodiments of the present disclosure, the rewards won page 1120 can display a list of prizes 1128a-1128n won by the user along with additional details. The user can further be provided with a redeem button 1130, and by clicking on the redeem button 1130 can redirect the user to a reward redemption page 1132 of the gaming application 110, as shown in FIG. 11D, according to embodiments of the present disclosure. The additional details can include, but are not limited to, the name of the reward won, a time of the reward won, a date of the reward won, a dimension of the reward won, a weight of the reward won, a time left for redeeming the reward won in the wallet as the coins, and so forth. Embodiments of the present disclosure are intended to include or otherwise cover any additional details that can be displayed on the rewards won page 1120 in the list of prizes 1128a-1128n, including known, related art, and/or later developed technologies.

FIG. 11D illustrates the reward redemption page 1132 of the gaming application 110, according to embodiments of the present disclosure. The reward redemption page 1132 can display a reward redemption banner 1134. According to embodiments of the present disclosure, the reward redemption banner 1134 can display the rewards 124 being redeemed 1136, and a total amount of coins 1138 that can be earned after successful redemption of the rewards being redeemed 1136. For example, as shown, a reward of a teddy bear can be exchanged for 30 coins. The reward redemption banner 1134 can further provide a confirm redeem button 1140. Clicking on the confirm redeem button 1140, the user can be redirected to a successful reward redemption page 1144 of the gaming application 110, as shown in FIG. 11E. According to embodiments of the present disclosure, the reward redemption banner 1134 can further provide a cancel button 1142. When the user clicks on the cancel button 1142, the user can be redirected to the rewards won page 1120 of the gaming application 110, as shown in FIG. 11C.

FIG. 11E illustrates the successful reward redemption page 1144 of the gaming application 110, according to embodiments of the present disclosure. The successful reward redemption page 1144 can provide a successful reward redemption banner 1146, according to embodiments of the present disclosure. According to embodiments of the present disclosure, the successful reward redemption banner 1146 can provide a cancel button 1142. When the user clicks on the cancel button 1142, the user can be redirected to the rewards won page 1120 of the gaming application 110, as shown in FIG. 11C. Further, the successful reward redemption banner 1146 can provide a play game button 1148. When the user clicks on the play game button 1148, the user can be redirected to the game catalog page 700.

FIG. 11F illustrates the shipped reward page 1150 of the gaming application 110, according to embodiments of the present disclosure. According to embodiments of the present disclosure, the shipped reward page 1150 can display a list of shipped rewards 1152a-1152o. The user can further click on any of the shipped rewards 1152a-1152o. When the user clicks on any of the shipped rewards 1152a-1152o, the user can be redirected to a reward shipment page 1158, as shown in FIG. 11H. The list of shipped rewards 1152a-1152o can be made visible under the shipped items tab 1124, according to embodiments of the present disclosure.

FIG. 11G illustrates the delivered reward page 1154 of the gaming application 110, according to embodiments of the present disclosure. According to embodiments of the present disclosure, the delivered reward page 1154 can display a list of delivered items/rewards 1156a-1156n. The list of delivered rewards 1156a-1156n can be made visible under the delivered items tab 1126, according to embodiments of the present disclosure.

FIG. 11H illustrates the reward shipment page 1158 of the gaming application 110, according to embodiments of the present disclosure. According to embodiments of the present disclosure, the reward shipment page 1158 can display details related to a reward shipment. The details related to the reward shipment can include, but are not limited to, the order identifier 1160, the date of order placed 1162, the shipping address for the corresponding order 1164, the name and quantity 1168 of the rewards 124 in the order, and so forth. Embodiments of the present disclosure are intended to include or otherwise cover any details related to reward shipment, including known, related art, and/or later developed technologies.

FIG. 12A illustrates a coin balance page 1200 of the gaming application 110, according to embodiments of the present disclosure. According to embodiments of the present disclosure, the coin balance page 1200 can display the balance of coins 912 in the wallet of the user. The coin balance page 1200 can further provide a balance history button 1202. Upon clicking on the balance history button 1202, the user can be redirected to a coin balance history page 1206 of the gaming application 110.

Further, the coin balance page 1200 can provide a popular coin package 1204a-1204n for crediting and/or adding the number of coins in the wallet. Upon clicking on any of the popular coin packages 1204a-1204n, the user can be redirected to a payment gateway for performing a transaction, according to embodiments of the present disclosure. On a successful transaction, the displayed number of coins as represented in the popular coin packages 1204a-1204n can be credited into the wallet of the user.

FIG. 12B illustrates the coin balance history page 1206 of the gaming application 110, according to embodiments of the present disclosure. The coin balance history page 1206 can display a list of transactions of coins 1208a-1208n performed previously by the user. The list of transactions of the coins 1208a-1208n performed can display additional details related to the transaction of coins 1208a-1208n performed, according to embodiments of the present disclosure. The additional details related to the transaction of coins 1208a-1208n performed can include, but are not limited to, the name of the game played, the time of the game played, the date of the game played, the expenditure of the coins for the game played, the earning of the coins from the game played, and so forth. Embodiments of the present disclosure are intended to include or otherwise cover any additional details related to the transaction of coins 1208a-1208n, including known, related art, and/or later developed technologies.

Although the systems and methods of the present disclosure have been described with reference to exemplary embodiments, such systems and methods are not limited thereto. Those skilled in the art will appreciate that numerous changes and modifications can be made to the exemplary embodiments of the present disclosure and that such changes and modifications can be made without departing from the true spirit of the present disclosure. It is therefore intended that the appended description be construed to cover all such equivalent variations as fall within the true spirit and scope of the present disclosure.

The exemplary embodiments of this present disclosure have been described in relation to playing arcade games from a remote location. However, to avoid unnecessarily obscuring the present disclosure, the preceding description omits a number of known structures and devices. This omission is not to be construed as a limitation of the scope of the present disclosure. Specific details are set forth by use of the embodiments to provide an understanding of the present disclosure. It should however be appreciated that the systems and methods of the present disclosure can be practiced in a variety of ways beyond the specific embodiments set forth herein.

A number of variations and modifications of the present disclosure can be used. It would be possible to provide for some features of the present disclosure without providing others.

The present disclosure, in various embodiments, configurations, and aspects, includes components, methods, processes, systems and/or apparatus substantially as depicted and described herein, including various embodiments, sub-combinations, and subsets thereof. Those of skill in the art will understand how to make and use the systems and methods of the present disclosure after understanding the disclosed embodiments of the present disclosure. The present disclosure, in various embodiments, configurations, and aspects, includes providing devices and processes in the absence of items not depicted and/or described herein or in various embodiments, configurations, or aspects hereof, including in the absence of such items as can have been used in previous devices or processes, e.g., for improving performance, achieving ease and/or reducing cost of implementation.

The foregoing discussion of the present disclosure has been presented for purposes of illustration and description. It is not intended to limit the present disclosure to the form or forms disclosed herein. In the foregoing Detailed Description, for example, various features of the present disclosure are grouped together in one or more embodiments, configurations, or aspects for the purpose of streamlining the disclosure. The features of the embodiments, configurations, or aspects can be combined in alternate embodiments, configurations, or aspects other than those discussed above. This method of disclosure is not to be interpreted as reflecting an intention the present disclosure requires more features than are expressly recited in each claim. Rather, as the foregoing description reflects, inventive aspects lie in less than all features of a single foregoing disclosed embodiment, configuration, or aspect.

Moreover, though the description of the present disclosure has included description of one or more embodiments, configurations, or aspects and certain variations and modifications, other variations, combinations, and modifications are within the scope of the present disclosure, e.g., as can be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system for remote game play comprising:
a game machine comprising local game controls and a local control unit, the local game controls configured to receive local player input and the local control unit configured to control an operation of the game machine based on the local player input;
a game controlling unit coupled to the local control unit and configured to control the operation of the game machine via the local control unit;
a video capture device, wherein the video capture device has a field of view of an exterior of the game machine; and
a media streaming unit coupled to the video capture device and configured to receive a video stream therefrom;
wherein the game controlling unit and the media streaming unit are communicatively coupled to a communication network; and
wherein the media streaming unit transmits the video stream to a remote gaming application via the communication network and the game controlling unit receives remote player input from the gaming application via the communication network and controls the operation of the game machine based on the remote player input.

2. The system of claim 1, wherein the media streaming unit streams a live view of the field of view of the game machine over the communication network.

3. The system of claim 1, wherein the media streaming unit is external to the game machine.

4. The system of claim 3, wherein the media streaming unit is configured to change the field of view based on the remote player input.

5. The system of claim 1, wherein the game controlling unit converts the remote player input into local control unit input.

6. The system of claim 5, wherein the game controlling unit converts a digital signal based on the remote player input into mechanical or optical in-person control unit input.

7. The system of claim 5, wherein the game controlling unit comprises a programmable logic control (PLC) or a microprocessor.

8. The system of claim 1, further comprising a second video capture device unit having a second field of view different than the first field of view and coupled to the media streaming device.

9. The system of claim 1, wherein a game of the game machine is initiated based on the remote player input.

10. A method for remote game play, the method comprising:
providing, at a first location:
a game machine comprising local game controls and a local control unit, the local game controls configured to receive local player input and the local control unit configured to control an operation of the game machine based on the local player input;
a game controlling unit coupled to the local control unit and configured to control the operation of the game machine via the local control unit;
a video capture device, wherein the video capture device has a field of view of an exterior of the game machine; and
a media streaming unit coupled to the video capture device and configured to receive a video stream therefrom;
capturing, by the media streaming unit, the video stream of the game machine;
establishing a network connection between the game controlling unit, the media streaming unit, and a remote gaming application at a second location;
transmitting, via the network connection, the video stream to the remote gaming application;
receiving, via the communication network, remote player input at the game controlling unit; and
controlling, by the game controlling unit, the game machine based on the remote user input.

11. The method claim 10, wherein the game controlling unit comprises a programmable logic control (PLC) or a microprocessor configured to control the local control unit.

12. The method claim 10, wherein the game controlling unit converts a digital signal based on the remote player input into mechanical or optical local control unit inputs.

13. The method claim 10, wherein the media streaming unit is external to the game machine and the field of view comprises a display of the game machine or a game play area of the game machine.

14. The method of claim 13, wherein the video stream is a live view of the display or the game play area.

15. The method of claim 10, further comprising synchronizing the video stream and the operation of the game machine.

16. The method of claim 10, further comprising determining if the game machine is available for remote game play or unavailable for remote game play.

17. The method of claim 16, further comprising enabling the game controlling unit to control the operation of the game machine based on a determination that the game machine is available.

18. The method of claim 17, comprising disabling control of the game machine by the game controlling unit based on a determination that the game machine is unavailable.

19. A real-time remote game play system, comprising:
a game machine provided at a first location, the game machine configured for in-person game play, wherein the game machine comprises a local control unit for receiving local player input;
a user device provided at a second location different than the first location, the user device configured to transmit remote player input from a remote player to the game machine;
a communication network communicatively coupling the game machine and the user device;
a media streaming unit comprising a video capture device capturing a video stream having a field of view including an exterior of the game machine and transmitting the video stream to the user device;
a turn broker configured to determine if the game machine is available for gameplay;
a game controlling unit coupled to the in-person control unit and the communication network;
wherein, based upon a determination that the game machine is available for gameplay, the game controlling unit converts the remote player input into local player input for controlling the game machine.

20. The real-time remote game play system of claim 19, further comprising:
a second game machine having a second local control unit configured to control the second game machine based upon input from a second local player;
wherein the communication network communicatively couples the second game machine and the user device;
a second game controlling unit coupled to the second local control unit; and
wherein, based upon a determination by the turn broker that the second game machine is available for gameplay, the second game controlling unit converts the remote player input into second local player inputs for controlling the second game machine.
